(19) United States
(12) Patent Application Publication
(10) Pub. No.: US 2015/0012881 A1
(43) Pub. Date: Jan. 8, 2015

(54) METHOD FOR CONTROLLING CHAT WINDOW AND ELECTRONIC DEVICE IMPLEMENTING THE SAME

(71) Applicant: Samsung Electronics Co., Ltd., Suwon-si (KR)

(72) Inventors: Sejun SONG, Seoul (KR); Dasom LEE, Seoul (KR); Yohan LEE, Seongnam-si (KR)

(21) Appl. No.: 14/321,106

(22) Filed: Jul. 1, 2014

(30) Foreign Application Priority Data
Jul. 8, 2013 (KR) 10-2013-0079614

(51) Int. Cl. G06F 3/0484

(52) U.S. Cl. CPC G06F 3/04847; G06F 3/04842
USPC 715/803

(57) ABSTRACT

A method for controlling a plurality of chat windows and an electronic device implementing the same are provided. The method includes displaying a first chat window on a messenger screen, receiving a message from the outside, and displaying the first chat window and a second chat window including the received message when the received message is irrelevant to the first chat window.

### CROSS-REFERENCE TO RELATED APPLICATION(S)

This application claims the benefit under 35 U.S.C. §119(a) of a Korean patent application filed on Jul. 8, 2013 in the Korean Intellectual Property Office and assigned Serial number 10-2013-0079614, the entire disclosure of which is hereby incorporated by reference.

### TECHNICAL FIELD

The present disclosure relates to a technology for controlling a chat window. More particularly, the present disclosure relates to a method for controlling a plurality of windows and an electronic device implementing the same.

### BACKGROUND

Electronic devices, through technological advances in hardware, are now able to support the operation of various functions. For example, an electronic device may provide a user with a function of chatting with a partner through data communication technologies. A message of the partner may be displayed on the left side of the chat window and a message of the user of a corresponding electronic device may be displayed on the right side.

An electronic device may simultaneously operate multiple chat windows. For example, a user may communicate with a chatting group A through a first chat window and may simultaneously communicate with a chatting group B through a second chat window. To this end, the electronic device may switch the chat window being displayed among the various active chat windows. For example, the chat window being displayed may be switched from the first chat window to the second chat window. However, the user may have difficulty in checking the conversation as they develop in each chat window. Hence, a need exists for an improved apparatus and method for displaying a plurality of chat windows on a single screen so as to enable chatting with many groups.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and apparatus for displaying a plurality of chat windows on a single screen so as to enable chatting with many chat groups.

Another aspect of the present disclosure is to provide a method and apparatus for enabling switching among chat windows.

In accordance with an aspect of the present disclosure, a method of operating an electronic device is provided. The method includes displaying a first chat window on a messenger screen, determining whether to display a second chat window, and displaying the first chat window and the second chat window on the messenger screen when it is determined that the second chat window is to be displayed.

In accordance with another aspect of the present disclosure, a method of operating an electronic device is provided. The method includes displaying a first chat window and at least one indicator on a messenger screen, detecting a user input that selects one of the at least one indicator, and terminating the display of the chat window and displaying a second chat window associated with the selected indicator on the messenger screen, in response to the user input.

In accordance with another aspect of the present disclosure, an electronic device is provided. The electronic device includes a display unit configured to display a messenger screen, a wireless communication unit configured to transmit and receive a message, a memory configured to store a chatting control module that is set to display a first chat window on the messenger screen, and, when it is determined that a second chat window is to be displayed, to display the first chat window and the second chat window on the messenger screen, and at least one processor configured to execute the chatting control module.

In accordance with another aspect of the present disclosure, an electronic device is provided. The electronic device includes a display unit configured to display a messenger screen, a wireless communication unit configured to transmit and receive a message, a memory configured to store a chatting control module that is set to display a first chat window and at least one indicator on the messenger screen, to detect a user input that selects one of the at least one indicator, to terminate the display of the chat window and to display a second chat window associated with the selected indicator on the messenger screen in response to the user input, and at least one processor configured to execute the chatting control module.

According to embodiments of the present disclosure, a method and apparatus for displaying multiple chat windows on a screen are provided so as to provide a user with a function of chatting with many chatting groups and a function of readily switching between displayed chat windows.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device according to an embodiment of the present disclosure;

FIG. 2A is a flowchart illustrating a method of displaying a plurality of chat windows according to an embodiment of the present disclosure;

FIG. 2B is a flowchart illustrating a method of displaying a plurality of chat windows according to an embodiment of the present disclosure;

FIGS. 3A, 3B, 3C, and 3D are screens for illustrating examples of a multi-displaying operation, such as operation 250 of FIG. 2, according to an embodiment of the present disclosure;

FIG. 4 is a flowchart illustrating a method of displaying a plurality of chat windows according to an embodiment of the present disclosure;

FIG. 5 is a screen for illustrating an example of an operation of displaying a notification bar, such as operation 430 of FIG. 4, according to an embodiment of the present disclosure;

FIGS. 6A, 6B, 6C, and 6D are screens for illustrating an example of a multi-displaying operation, such as operation 450 of FIG. 4, according to an embodiment of the present disclosure;

FIGS. 7A, 7B, 7C, and 7D are screens for illustrating an example of a multi-displaying operation, such as operation 450 of FIG. 4, according to an embodiment of the present disclosure;

FIG. 8 is a screen for illustrating an example of a multi-displaying operation, such as operation 450 of FIG. 4, according to an embodiment of the present disclosure;

FIGS. 9A, 9B, 9C, and 9D are screens for illustrating an example of an operation of displaying three or more chat windows on a messenger screen according to an embodiment of the present disclosure;

FIG. 10 is a screen for illustrating an operation of terminating a display of a notification bar, such as operation 480 of FIG. 4, according to an embodiment of the present disclosure;

FIG. 11 is a flowchart for illustrating a method of displaying a plurality of chat windows according to an embodiment of the present;

FIGS. 12A and 12B are screens for illustrating an example of displaying remaining chat windows excluding at least one existing chat window and a new chat window including a received message, such as operation 1170 of FIG. 11, according to an embodiment of the present disclosure;

FIG. 13 is a flowchart illustrating a method of displaying a plurality of chat windows according to an embodiment of the present;

FIG. 14 is a screen for illustrating an example of an operation of setting a displayed chat window to be an active window according to an embodiment of the present disclosure;

FIG. 15 is a screen for illustrating an example of an operation of setting a displayed chat window to be an active window according to an embodiment of the present disclosure;

FIGS. 16A and 16B are screens for illustrating an example of an operation of terminating a multi-displaying mode according to an embodiment of the present disclosure;

FIG. 17 is a flowchart illustrating a method of selectively displaying one of a plurality of chat windows according to an embodiment of the present disclosure; and

FIG. 18A and FIG. 18B are screens for illustrating an example of displaying a chat window corresponding to a selected indicator on a messenger screen, such as operation 1730 of FIG. 17, according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An electronic device according to an embodiment of the present disclosure refers to a device including a communication function for chatting, and may include, for example, a smart phone, a tablet Personal Computer (PC), a notebook PC, a digital camera, a smart TeleVision (TV), a Personal Digital Assistant (PDA), an electronic scheduler, a desktop PC, a Portable Multimedia Player (PMP), a media player (for example, an MP3 player), a sound system, a smart wrist watch, a game terminal, an electrical appliance (for example, a refrigerator, a TV, a washing machine, etc.) including a touch screen, and the like.

An electronic device according to an embodiment of the present disclosure may display multiple chat windows on a messenger screen. Here, the messenger screen may be an entirety or a portion of a screen of the corresponding electronic device.

An electronic device according to an embodiment of the present disclosure may display a new chat window including a received message together with an existing chat window when a message is received from the outside, the received message corresponding to the new chat window that is different from the existing chat window that is being displayed on a messenger screen. In this example, the existing chat window and the new chat window may be displayed to be different from each other. For example, i) a function of displaying only messages from a partner, ii) a function of displaying messages from a user to be relatively smaller, or iii) a function of displaying a size of a chat window to be smaller than the existing chat window may be applied to the new chat window. As a matter of course, the functions may be applied to the existing chat window. Also, the existing chat window may be an active window and the new chat window may be an inactive window or vice versa. Also, both the existing chat window and the new chat window may be active windows. Here, the active window may be defined to be a chat window of a currently available chatting group. That is, the corresponding electronic device may transmit a message to a chatting group of an active window when it receives a request for transmission of a message from the user. The transmitted message may be displayed on the active window as the messages from the user.

An electronic device according to an embodiment of the present disclosure may generate a new chat window while an existing chat window is displayed on a messenger screen, and may simultaneously display the existing chat window and the new chat window in a manner similar to the above descriptions.

An electronic device according to an embodiment of the present disclosure may display a notification bar when a message is received from the outside, the message corresponding to a chat window that is different from a chat window that is being displayed on a messenger screen. When the user selects the notification bar (for example, a touch on the displayed notification bar, dragging to the inside of the screen, or the like), the electronic device may display a plurality of chat windows on the messenger screen. In this example, the properties of a chat window may vary based on a distance of a movement of a touch input device (for example, a finger, a pen, or the like) made on the messenger screen.

An electronic device according to an embodiment of the present disclosure may adjust the number of chat windows to be displayed. That is, the electronic device may remove (or terminate displaying) one of the existing chat windows, so as to display a new chat window.

An electronic device according to an embodiment of the present disclosure may set one of the chat windows displayed on a messenger screen to an active window. In this example, a user input for setting may be a touch of a touch input device on an inactive window, a movement of a touch input device on a chat window dividing line, and the like. Also, when a new message is received, the electronic device may set a corresponding chat window to an active window.

An electronic device according to an embodiment of the present disclosure may display one of the chat windows on a messenger screen, and may display, on the messenger screen, indicators corresponding to the remaining chat windows. When the user selects an indicator, the electronic device may display a corresponding chat window on the messenger screen. Also, when a new message corresponding to a chat window that is not displayed on the messenger screen is received, the electronic device may display a notification indicating that the message is received.

Hereinafter, various embodiments of the present disclosure will be described with reference to the accompanying drawings.

In describing the various embodiments of the present disclosure, descriptions related to technical contents which are well-known in the art to which the present disclosure pertains, and are not directly associated with the present disclosure, will be omitted. Also, the descriptions of the component elements that have substantially identical configurations and functions will be omitted.

For a similar reason, a few component elements in the attached drawings may be illustrated to be exaggerated or omitted, or may be schematically illustrated, and a size of each component element may not completely reflect an actual size. Therefore, the present disclosure is not limited to a relative size or distance indicated in the accompanying drawings.

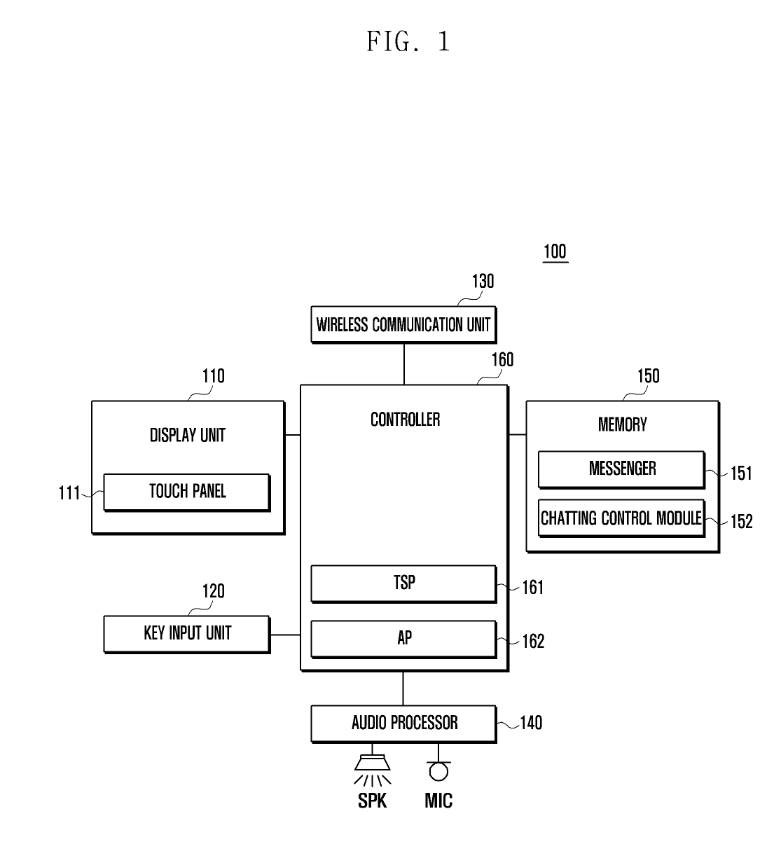

FIG. 1 is a block diagram of an electronic device according to an embodiment of the present disclosure.

Referring to FIG. 1, an electronic device 100 may include a display unit 110, a key input unit 120, a wireless communication unit 130, an audio processor 140, a Speaker (SPK), a Microphone (MIC), a memory 150, and a controller 160.

The display unit 110 may display various pieces of information on a screen based on a control of the controller 160, such as, an Application Processor (AP). For example, when the controller 160 processes (for example, decodes) information and stores the processed information in a memory (for example, a frame buffer), the display unit 110 may convert data stored in the frame buffer to an analog signal and display the analog signal on the screen. The display unit 110 may be formed of a Liquid Crystal Display (LCD), an Active Matrix Organic Light Emitted Diode (AMOLED), a flexible display, or a transparent display.

When power is supplied to the display unit 110, a lock image may be displayed on the screen. When a user input (for example, a password) for unlocking is detected in a state where the lock image is displayed, the controller 160 may execute the unlocking. When the unlocking is executed, the display unit 110 may display, for example, a home image instead of the lock image on the screen based on a control of the controller 160. The home image may include a background image (for example, a picture set by a user) and icons displayed on the background image. Here, the icons indicate applications or contents, that is, an image file, a video file, a recording file, a document, a message and the like, respectively. When a user input for executing one of the icons is detected, the controller 160 may execute the corresponding application (for example, a messenger), and may control the display unit 110 to display an execution image. The screen may be referred to as a name associated with a display target. For example, a screen that displays a lock image, a screen that displays a home image, and a screen that displays an execution image of an application may be referred to as a lock screen, a home screen, and an execution screen, respectively. For example, an execution screen that displays an execution image of a messenger may be referred to as a ‘messenger screen’.

The display unit 110 may display chat windows on a messenger screen based on a control of the controller 110. Each chat window may include messages from a user and messages from a partner. The messages from the partner may be displayed on the left side of a corresponding chat window. Also, identification information (for example, a name, an identification (ID), a thumbnail, and the like) of a partner may be displayed together with the messages from the partner. The messages from the user may be displayed on the right side of the corresponding chat window. As a matter of course, the positions of the messages from the user and the partner may be changed based on a design. That is, the messages from the user may be displayed on the left side and the messages from the partner may be displayed on the right side.

The display 110 may display the chat windows to be different from one another, based on a control of the controller 160. For example, the display unit 110 may display an active window and an inactive window to have different properties from each other. Information associated with the properties may include at least one of, for example, a font color, a font, a font size, a size of a chat window, a size of a word box, a shape of a word box, a color of a word box, an amount of message (that is, the number of word boxes), a type of a message, and the like. Also, the display unit 110 may display a new chat window (for example, the last displayed chat window among displayed chat windows (that is, the latest one)) and existing chat windows, to have different properties from each other. For example, the type of displayed message may be restricted in at least one of the chat windows (for example, a new chat window, an existing chat window, an active window, or an inactive window). For example, the messages from the user (a transmitted message from a position of the corresponding electronic device) are not displayed, and only the messages from the partner (a received message from the position of the corresponding electronic device) may be displayed on the corresponding chat window. Also, the messages from the user may be displayed to be relatively smaller in at least one of the chat windows. Also, at least one of the chat windows may be displayed to be smaller than the other chat windows. Also, a size of a word box may be displayed to be relatively smaller in at least one of the chat windows.

A touch panel 111 is installed in the screen of the display unit 110. For example, the touch panel 111 may be embodied as an add-on type touch panel which is placed on the screen of the display unit 110, or an on-cell type or in-cell type touch panel which is inserted in the display unit 110. Also, the touch panel 111 may generate an event (for example, an approach event, a hovering event, a touch event or the like) in response to a user input (for example, an approach, hovering, a touch or the like) of a pointing device (for example, a finger or a pen) on the screen of the display unit 110, that is, a touch screen, may Analog to Digital (AD)-convert the generated event, and may transmit the converted event to the controller 160, particularly, a touch screen controller. When the pointing device approaches the touch screen, the touch panel 111 generates an approach event in response to the approach, and may transfer the approach event to the touch screen controller. The approach event may include information associated with a movement and a direction of the pointing device. When the pointing device hovers over the touch screen, the touch panel 111 generates a hovering event in response to the hovering, and may transfer the hovering event to the touch screen controller. Here, the hovering event may include raw data, for example, one or more hovering coordinates (x_hovering, y_hovering). When the pointing device touches the touch screen, the touch panel 111 generates a touch event in response to the touch, and may transfer the touch event to the touch screen controller. Here, the touch event may include raw data, for example, one or more touch coordinates (x_touch, y_touch).

The touch panel 111 may be a complex touch panel, including a hand touch panel that detects a hand input and a pen touch panel that detects a pen touch. Here, the hand touch panel may be embodied as a capacitive type. It goes without saying that the hand touch panel may be embodied as a resistive-type touch panel, an infrared-type touch panel, or an ultrasonic-type touch panel. Also, the hand touch panel may not generate an event through a body part, and may generate an event through other objects (for example, a conductive object that may apply a change in a capacitance). The pen touch panel (referred to as a digitizer sensor board) may be formed in an Electro-Magnetic Resonance (EMR) type. Accordingly, the pen touch panel may generate an event through a pen that is specially manufactured to form a magnetic field. The pen touch panel may generate a key event. For example, when a button installed in a pen is pressed, a magnetic field generated from a coil of the pen may be changed. The pen touch panel may generate a key event in response to the change in the magnetic field and may transmit the generated key event to the controller 160, particularly, the touch screen controller.

The key input unit 120 may be configured to include at least one touch key. The touch key refers to all types of input means that may recognize a touch or an approach of a body part and an object, generally. For example, a touch key may include a capacitive touch key that senses an approach of a body part or an object that is capacitive, and may recognize the sensed approach as a user input. The touch key may generate an event in response to a touch of the user and may transmit the generated event to the controller 160.

The key input unit 120 may further include a key in a different type from the touch type. The key input unit 120 may be configured to include at least one dome key. When the user presses the dome key, the dome key is transformed to be in contact with a printed circuit board, and accordingly, a key event is generated on the printed circuit board and transmitted to the controller 160. Meanwhile, keys of the key input unit 120 may be referred to as hard keys, and keys displayed on the display unit 110 may be referred to as soft keys.

The wireless communication unit 130 may perform a voice call, a video call, or data communication with an external device through a network under a control of the controller 160. The wireless communication unit 130 may include a mobile communication module, for example, a third-generation (3G) mobile communication module, a 3.5-generation mobile communication module, a fourth-generation mobile communication module, or the like, a digital broadcasting module, for example, a Digital Multimedia Broadcasting (DMB) module, and a short-range communication module, for example, a WiFi module, a Bluetooth module or a Near Field Communication (NFC) module.

The audio processor 140 is coupled with the SPK and the MIC to perform an input and output of audio signals (for example, voice data for voice recognition, voice recording, digital recording, and call). The audio processor 140 receives an audio signal, for example, voice data, from the controller 160, D/A-converts the received audio signal to an analog signal, amplifies the analog signal, and then outputs the analog signal to the SPK. The SPK converts an audio signal received from the audio processor 140 into a sound wave, and outputs the sound wave. The MIC converts sound waves transferred from a user or other sound sources into audio signals. The audio processor 140 A/D-converts an audio signal received from the MIC to a digital signal and transmits the digital signal to the controller 160.

The audio processor 140 may provide an auditory feedback in response to the reception of a message based on a control of the controller 160. For example, when a message is received by the electronic device 100, the audio processor 140 may play back voice data or sound data that indicates the reception. Also, when a display mode of a messenger screen is changed from a multi-displaying mode into a uni-displaying mode or is changed in reverse, the audio processor 140 may play back voice data or sound data indicating the change. Here, the multi-displaying mode refers to a mode that displays a plurality of chat windows on a messenger screen, and the uni-displaying mode refers to a mode that displays a single chat window on a messenger screen. Also, when an active window is changed, the audio processor 140 may play back voice data or sound data indicating the change. For example, when the active window is changed from a first chat window to a second chat window, property information associated with the second chat window (for example, a name of a corresponding chat window or the like) may be output in voice.

The memory 150 may store data generated according to an operation of the electronic device 100 or received from the outside through the wireless communication unit 130 under a control of the controller 160. The memory 150 may include a buffer for temporary data storage. For example, the memory 150 may store history information for each chat window. The history information for each chat window may include messages from a user, transmission time information associated with messages from a user, messages from a partner, reception time information associated with messages from a partner, and identification information of a partner (for example, a telephone number, an ID, a thumbnail, and the like). Also, the memory 150 may store priority information for each chat window. The priority information may be used as information for determining an active window from among displayed chat windows. Also, the priority information may be used as information for adjusting the number of chat windows to be displayed.

The memory 150 may store various pieces of setting information, for example, screen brightness, whether to generate a vibration when a touch is generated, whether to automatically rotate a screen, for setting a use environment of the electronic device 100, and the like. Accordingly, the controller 160 may operate the electronic device 100 based on the setting information.

The memory 150 may store various programs for operating the electronic device 100, for example, a boot-up program, one or more operating systems, and one or more applications. For example, the memory 150 may store a messenger 151 and a chatting control module 152. Here, the messenger 151 may be a program that is set to exchange a message with an external device. For example, the messenger 151 may include an instant messenger, an Short Message Service/Multimedia Message Service (SMS/MMS) messenger, and the like.

The chatting control module 152 may be a program that is set to control a display of a chat window. For example, when a message that is irrelevant to an existing chat window, such as a chat window that is displayed on a messenger screen, is received, the chatting control module 152 is set to divide the messenger screen so as to display the existing chat window and a new chat window including the received message. Also, the chatting control module 152 may be set to display chat windows to be different from each other. The displaying operation may include displaying each chat window to have different property information, for example, a font color, a font, a font size, a size of a word box (for example, in a shape of bubble), a shape of a word box, a color of a word box, a size of a chat window, an amount of message (that is, the number of word boxes), a type of a message, or the like.

When a message that is irrelevant to the existing chat window, for example, a chat window that is being displayed on a messenger screen, is received, the chatting control module 152 may be set to output a notification message for indicating the reception of the message, for example, playback of voice data, display of a notification bar, providing a vibration, and the like, and to display the existing chat window and a new chat window including the received message on the messenger screen in response to a request of a user.

The chatting control module 152 may be set to set priorities of chat windows, and to set one of the chat windows to be an active window based on the set priority information. Here, for the priority setting operation, history information stored in the memory 150 may be used. For example, a chat window that most recently received a message from a partner may be set to have the highest priority. Also, a chat window that was most recently displayed among the displayed chat windows may be set to have the highest priority. Also, a chat window that most recently transmits messages of the user may be set to have the highest priority.

The chatting control module 152 may be set to adjust the number of chat windows to be displayed, to set a chat window selected (for example, a tap on a chat window) by the user from among the displayed chat windows, and to display one of the chat windows and to display indicators instead of the remaining chat windows. Here, for the adjustment operation, the priority information stored in the memory 150 may be used. For example, when a new chat window is displayed on the messenger screen, a chat window having the lowest priority among the displayed existing chat windows may be terminated.

The memory 150 may include a main memory and a secondary memory. The main memory may be embodied as, for example, a Random Access Memory (RAM) or the like. The secondary memory may be embodied as a disk, a RAM, a Read Only Memory (ROM), a flash memory, or the like. The main memory may store various programs loaded from the secondary memory, for example, a boot-up program, an operating system, and applications. When power of a battery is supplied to the controller 160, the boot-up program may be loaded first to the main memory.

The boot-up program may load the operating system to the main memory. The operating system may load an application (for example, the chatting control module 152) to the main memory. The controller 160 (for example, an AP) may access the main memory to decode a command (routine) of the program, and may execute a function according to a decoding result. That is, the various programs may be loaded to the main memory and run as processes.

The controller 160 controls general operations of the electronic device 100 and a signal flow among internal components of the electronic device 100, performs a function of processing data, and controls the supply of power to the components from the battery. The controller 160 may include a touch screen controller (e.g., Touch Screen Processor (TSP)) 161 and an AP 162.

When the touch screen controller 161 receives a hovering event from the touch panel 111, the touch screen controller 161 may recognize the generation of the hovering. The touch screen controller 161 may determine a hovering area on the touch screen in response to the hovering, and may determine hovering coordinates (x_hovering and y_hovering) in the hovering area. The touch screen controller 161 may transmit the determined hovering coordinates to, for example, the AP 162. Also, sensing information for determining a depth of the hovering event may be included. For example, the hovering event may include three-dimensional (3D) hovering coordinates (x, y, z). Here, a z value may refer to the depth. When the touch screen controller 161 receives a touch event from the touch panel 111, the touch screen controller 161 may recognize generation of the touch. The touch screen controller 161 may determine a touch area on the touch screen in response to the touch, and may determine touch coordinates (x_touch and y_touch) in the touch area. The touch screen controller 161 may transmit the determined touch coordinates to, for example, the AP 162.

When the AP 162 receives the hovering coordinates from the touch screen controller 161, the AP 162 may determine that the pointing device hovers over the touch screen. When the AP 162 does not receive the hovering coordinates from the touch panel 111, the AP 162 may determine that the hovering of the pointing device is released from the touch screen. Further, when hovering coordinates are changed and a variance in the hovering coordinates exceeds a movement threshold, the AP 162 may determine that a hovering movement of the pointing device is generated. The AP 162 may determine a variance in a position (dx and dy) of the pointing device, a movement speed of the pointing device, and a trajectory of the hovering movement in response to the hovering movement of the pointing device. In addition, the AP 162 may determine a user's gesture on the touch screen based on the hovering coordinate, whether the hovering of the pointing device is released, whether the pointing device moves, the variance in the position of the pointing device, the movement speed of the pointing device, the trajectory of the hovering movement, and the like. Here, the gesture of the user may include, for example, dragging, flicking, pinching in, pinching out, and the like.

When the AP 162 receives the touch coordinates from the touch screen controller 161, the AP 162 may determine that the pointing device touches the touch panel 111. When the AP 162 does not receive the touch coordinates from the touch panel 111, the AP 162 may determine that the touch of the pointing device is released from the touch screen. Further, when touch coordinates are changed and a variance in the touch coordinates exceeds a movement threshold, the AP 162 may determine that a touch movement of the pointing device is generated. The AP 162 may determine a variance in a position (dx and dy) of the pointing device, a movement speed of the pointing device, and a trajectory of the touch movement in response to the touch movement of the pointing device. In addition, the AP 162 may determine a user's gesture on the touch screen based on the touch coordinates, whether the touch of the pointing device is released, whether the pointing device moves, the variance in the position of the pointing device, the movement speed of the pointing device, the trajectory of the touch movement, and the like. Here, the user's gesture may include a touch, a multi-touch, a tap, a double-tap, a long tap, a tap & touch, dragging, flicking, pressing, pinching in, pinching out, and the like.

The AP 162 may execute various types of programs stored in the memory 150. That is, the AP 162 may load various programs from the secondary memory to the main memory, so as to execute the same processes. For example, the AP 162 may execute the chatting control module 152. As a matter of course, the chatting control module 152 may be executed by a processor different from the AP 162, for example, a Central Processing Unit (CPU).

The controller 160 may further include various processors in addition to the AP 162. For example, the controller 160 may include one or more CPUs. Further, the controller 160 may include a Graphic Processing Unit (GPU). When the electronic device 100 includes a mobile communication module (for example, a 3G mobile communication module, a 3.5G mobile communication module, a 4G mobile communication module or the like), the controller 160 may further include a Communication Processor (CP). For each processor described above, two or more independent cores (for example, quad-cord) may be integrated into a single package formed of an Integrated-Circuit (IC). For example, the AP 162 may be integrated into one multi-core processor. The described processors (for example, an application processor and an ISP) may be integrated into a single chip (e.g., System on Chip (SoC)). Also, the described processors (for example, an application processor and an ISP) may be packaged into a multi-layer.

The electronic device 100 may further include an earphone jack, a proximity sensor, an illumination sensor, a Global Positioning Sensor (GPS) reception module, a camera, an acceleration sensor, a gravity sensor, and the like, which are not mentioned in the above.

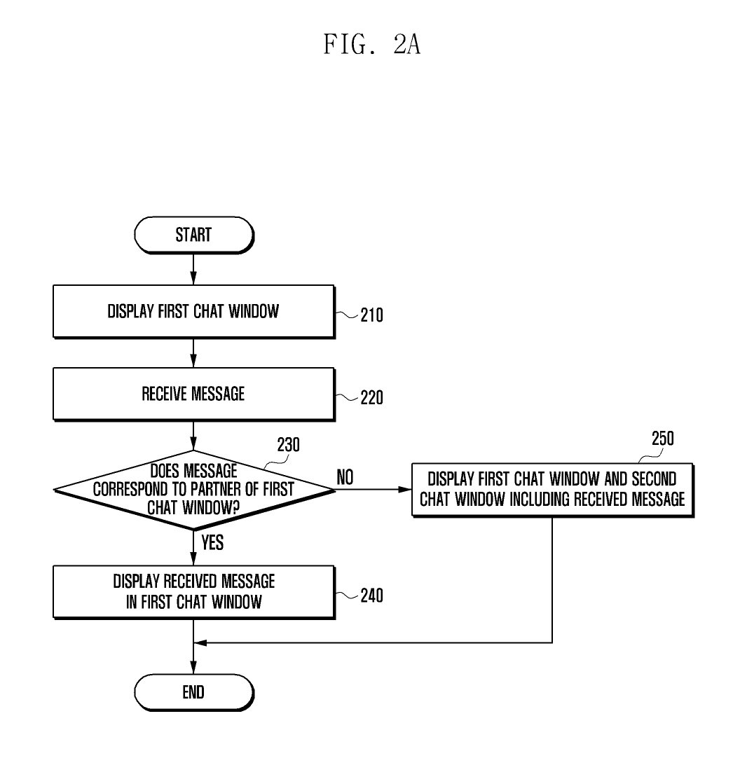

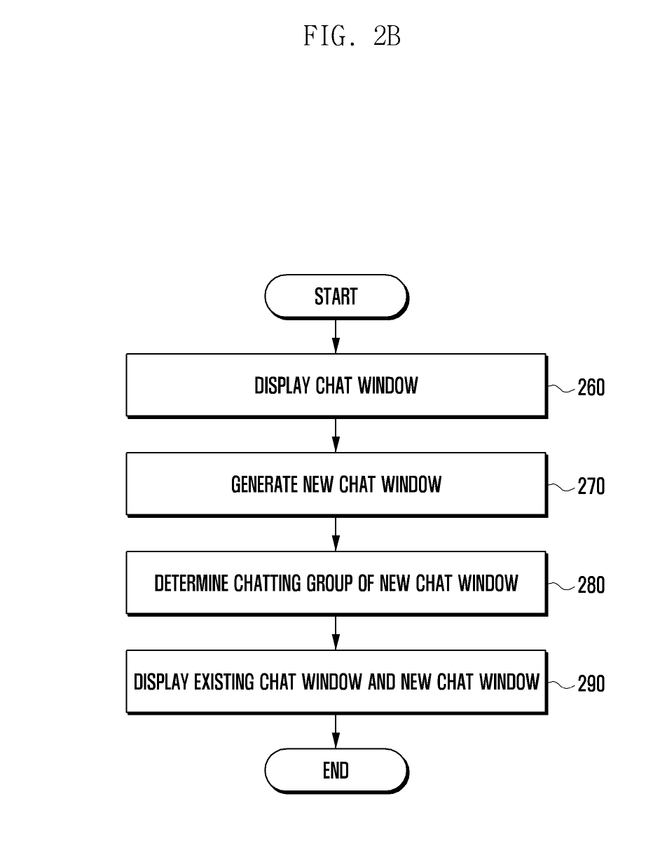

FIG. 2A is a flowchart illustrating a method of displaying a plurality of chat windows according to an embodiment of the present disclosure.

Referring to FIG. 2A, the controller 160 controls the display unit 110 to display a first chat window, in operation 210. For example, when an icon corresponding to the messenger 151 is selected by a user on a home screen, the controller 160 may execute the messenger 151. As the messenger 151 is executed, the first chat window may be displayed on a messenger screen. As another example, the controller 160 may receive a message through the wireless communication unit 130 from the outside. The controller 160 may notify the user that the message is received. Here, a method of notification may include the playback of voice or sound data, providing a vibration through a vibration motor, displaying a pop-up window, and the like. When the user requests the received message be displayed, the controller 160 may execute the messenger 151 in response to the request. Therefore, the first chat window including the received message (e.g., the messages of a partner) may be displayed on the messenger screen. In this example, the first chat window may be a new chat window or an existing chat window. For example, when the message is received, the controller 160 may read history information stored in the memory 150, and may control the display unit 110 to display an existing chat window corresponding to the received message when history information corresponding to the received message exists among the read history information. When the history information corresponding to the received message does not exist among the read history information, the controller 160 may generate a new chat window and may control the display unit 110 to display the new chat window including the received message on the messenger screen.

In operation 220, the controller 160 receives a message through the wireless communication unit 130 from the outside. Here, while operation 210 is executed by reception of the message, the received message in operation 220 is different from the received message in operation 210

When the message is received in operation 220, the controller 160 may determine whether the received message is sent by the partner of the first chat window in operation 230. For example, the controller 160 determines identification information associated with the partner of the first chat window (for example, a telephone number, an ID, a name, and the like). When information identical to sender information of the received message exists in the determined identification information of the partner, the controller 160 may determine that the received message corresponds to the partner of the first chat window.

When it is determined that the received message corresponds to the partner of the first chat window in operation 230, the controller 160 may control the display unit 110 to display the received message in the first chat window in operation 240.

When it is determined that the received message is irrelevant to the first chat window in operation 230, the controller 160 may control the display unit 110 to display a second chat window including the received message on the messenger screen, together with the first chat window in operation 250.

FIG. 2B is a flowchart illustrating a method of displaying a plurality of chat windows according to an embodiment of the present disclosure.

Referring to FIG. 2B, the controller 160 may control the display unit 110 to display a chat window in operation 260. In operation 270, the controller 160 may generate a new chat window. Here, operation 270 may be executed by input of a soft key or a hard key, providing an additional input after generating a separate option window through the corresponding input, or a hovering event. Also, operation 270 may be executed by various schemes such as a voice input, inputs of other sensors, or the like. In operation 280, the controller 160 may determine a chatting group of the new chat window. When the chatting group is determined, the controller 160 may control the display unit 110 to display an existing chat window and the new chat window on the messenger screen in operation 290.

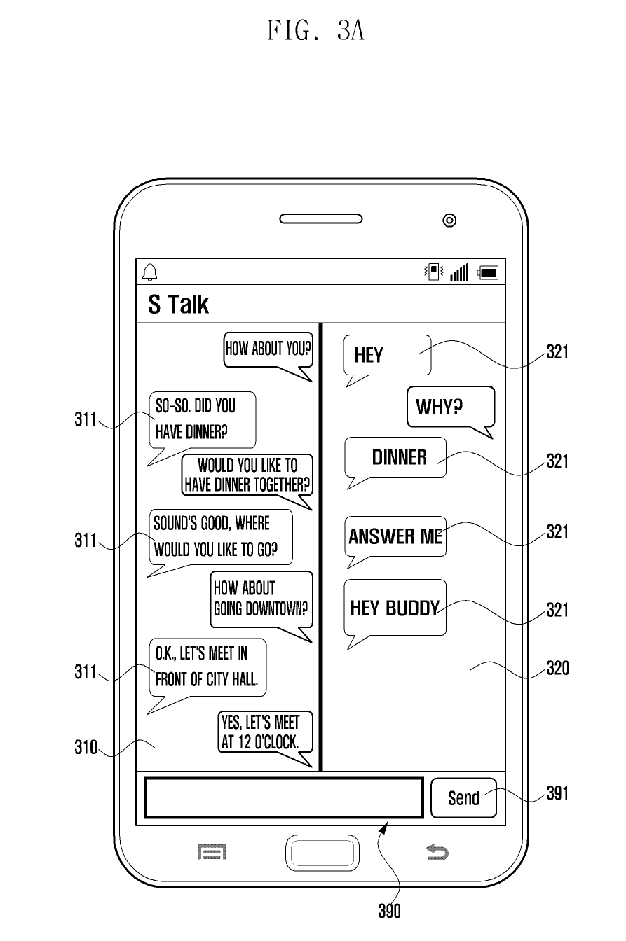

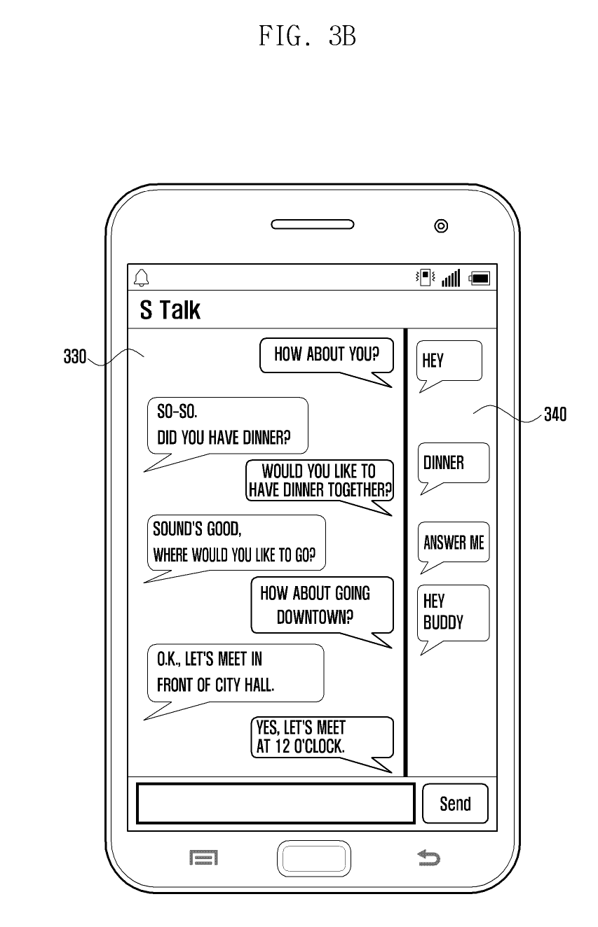

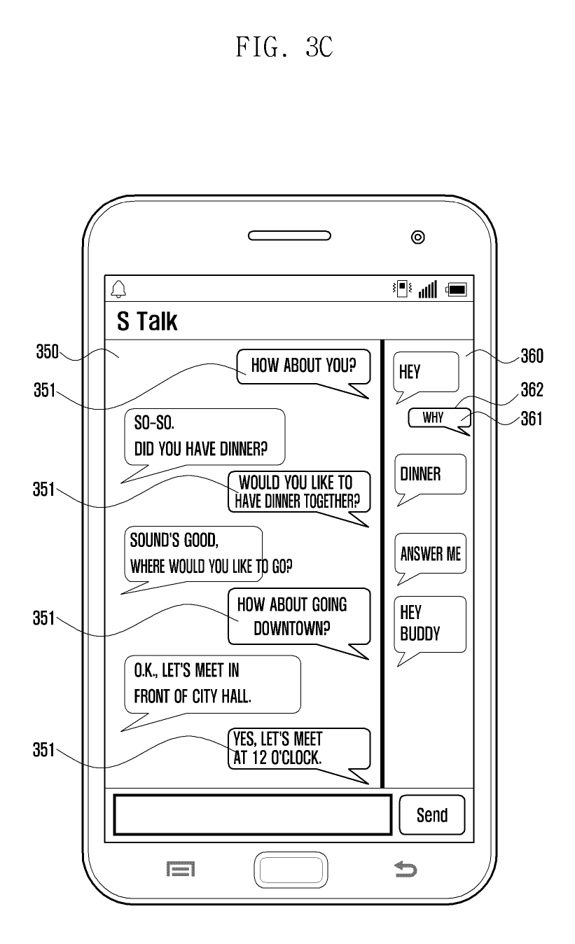

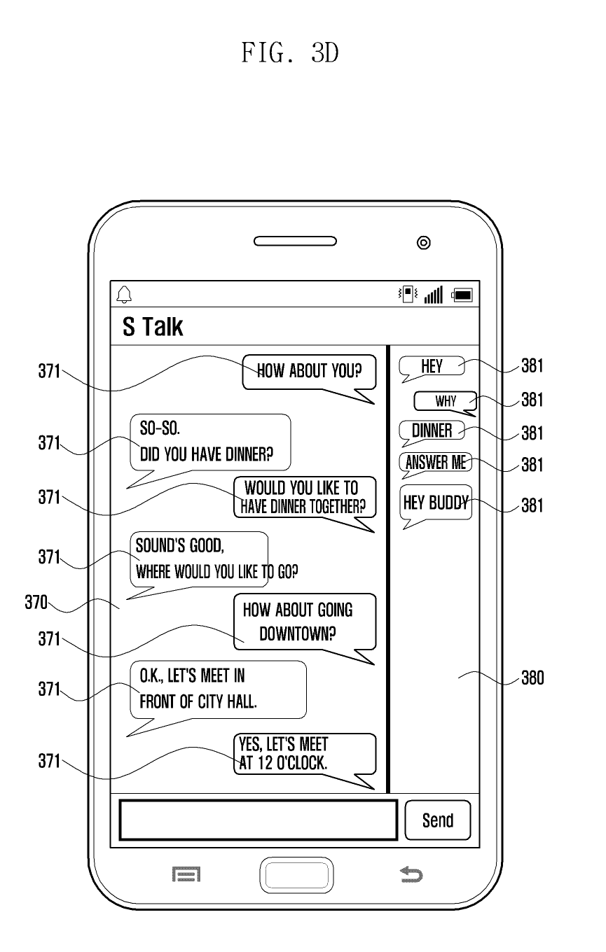

FIGS. 3A, 3B, 3C, and 3D are screens for illustrating examples of a multi-displaying operation, such as operation 250 of FIG. 2, according to an embodiment of the present disclosure.

Referring to FIG. 3A, messages from a partner of a first chat window 310 and messages from a partner of a second chat window 320 may be displayed to be different from each other. For example, a background color of a word box of messages 311 from a partner may be a first color in the first chat window 310, and a background color of a word box of messages 321 from a partner may be a second color in the second chat window 320. The remaining properties excluding the background colors of the word boxes may be identical. For example, as illustrated in FIG. 3A, sizes of chat windows, sizes of word boxes, font sizes, background colors of word boxes of messages from the user, and the like may be identical.

When an input window 390 is selected (when the user taps on the input window 390), the controller 160 may control the display unit 110 to display a keypad on the messenger screen. In this example, the key pad may overlap the chat windows. A message input through the keypad may be displayed on the input window 390. When transmission of the message is selected (a tap on a transmission button 391), the controller 160 may control the wireless communication unit 130 to transmit the message displayed on the input window 390 to a chatting group in an active window. Also, the controller 160 may control the display unit 110 to display a transmitted message (the message from the user) on an active window. Here, the active window may be a chat window that is most recently displayed, for example, the second chat window 320. Also, the active window may be a window selected by the user. For example, when the user taps on the first chat window 310, in response to the tap, the controller 160 sets the first chat window 310 to be the active window, and sets the second chat window 320 to be an inactive window. When transmission of the message is selected, the controller 160 may control the wireless communication unit 130 to transmit the message displayed on the input window 390 to various chatting groups. That is, the user may simultaneously transmit an identical message to various chatting groups using a single input window. Also, the controller 160 may control the display unit 110 to display a transmitted message in a plurality of chat windows.

As illustrated in FIG. 3A, a single input window may be displayed. Also, an input window may be displayed for each chat window. That is, the controller 160 may control the display unit 110 to display input windows corresponding to respective chat windows. When one of the input windows is selected (for example, a tap on a corresponding input window), the controller 160 may set a chat window corresponding to the selected input window to be the active window.

Referring to FIG. 3B, the type of messages to be displayed may be restricted in a second chat window 340 among a first chat window 330 and the second chat window 340. For example, as illustrated in FIG. 3B, the messages of the user may be omitted in the second chat window 340. Accordingly, the first chat window 330 may be displayed to be larger than the second chat window 340.

Referring to FIG. 3C, messages 361 from the user displayed in a second chat window 360 may be displayed to be relatively smaller than messages 351 from the user displayed on a first chat window 350. The size of a word box 362 of messages 361 from the user may be displayed to be smaller.

Referring to FIG. 3D, all messages 381 displayed in a second chat window 380 may be displayed to be relatively smaller than messages 371 of the user displayed in a first chat window 370. Also, the size of a word box may be displayed to be smaller.

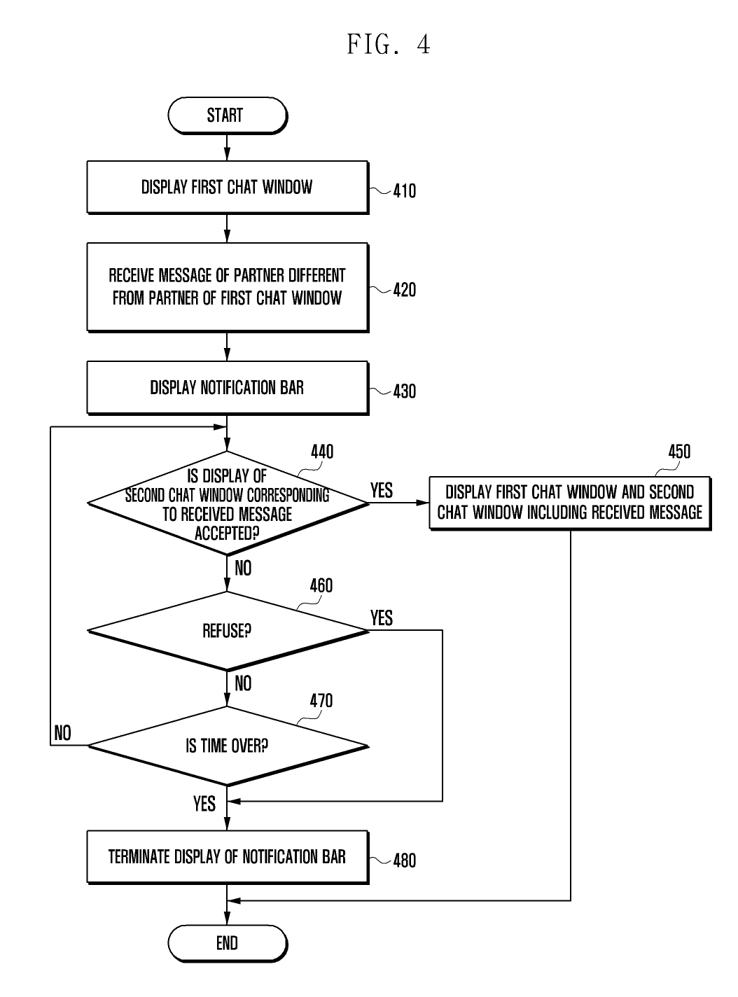

FIG. 4 is a flowchart illustrating a method of displaying a plurality of chat windows according to an embodiment of the present disclosure.

Referring to FIG. 4, the controller 160 may control the display unit 110 to display a first chat window on a messenger screen in operation 410.

In operation 420, the controller 160 receives a message through the wireless communication unit 130 from the outside.

When the message received in operation 420 is irrelevant to a first chat window, the controller 160 may control the display unit 110 to display a notification bar in operation 430. Also, in operation 430, the controller 160 may control the audio processor 140 to play back voice (or sound) data so as to notify the user that the message that does not correspond to the first chat window is received. Also, the controller 160 may vibrate a vibration motor in operation 430.

In operation 440, the controller 160 may determine whether a user input (hereinafter, an accept input) that allows the display of a second chat window corresponding to the received message is detected. For example, when the user taps on the notification bar, the touch panel 111 may transfer an event associated with this to the controller 160. The controller 160 may detect the tap through the touch panel 111 and may recognize the tap as an accept input. Also, when the user drags the notification bar to the inside of the messenger screen, the controller 160 may recognize the dragging as an accept input. Also, when the user presses a hard key, the key input unit 120 may transfer an event associated with this to the controller 160. The controller 160 may detect the press of the hard key through the key input unit 120, and may recognize the press as an accept input.

When the accept input is detected in operation 440, the controller 160 may control the display unit 110 to display the second chat window including the received message on the messenger screen, together with the first chat window in operation 450.

When the accept input is not detected in operation 440, the controller 160 may determine whether a user input that refuses the display of the second chat window (hereinafter, a refusal input) is detected in operation 460. For example, when the user drags the notification bar to the outside of the messenger screen, the controller 160 may recognize the dragging as a refusal input. When the refusal input is detected in operation 460, the process may proceed with operation 480.

When the refusal input is not detected in operation 460, the controller 160 may determine whether a critical time passes in operation 470. For example, the controller 160 may count a time from a point in time of receiving a message (or displaying a notification bar). When the counted time does not exceed the critical time, the process may return to operation 440.

When the counted time exceeds the critical time, the process may proceed with operation 480. Alternatively, when the counted time exceeds the critical time, the process may proceed with operation 450.

In operation 480, the controller 160 may terminate the display of the notification bar.

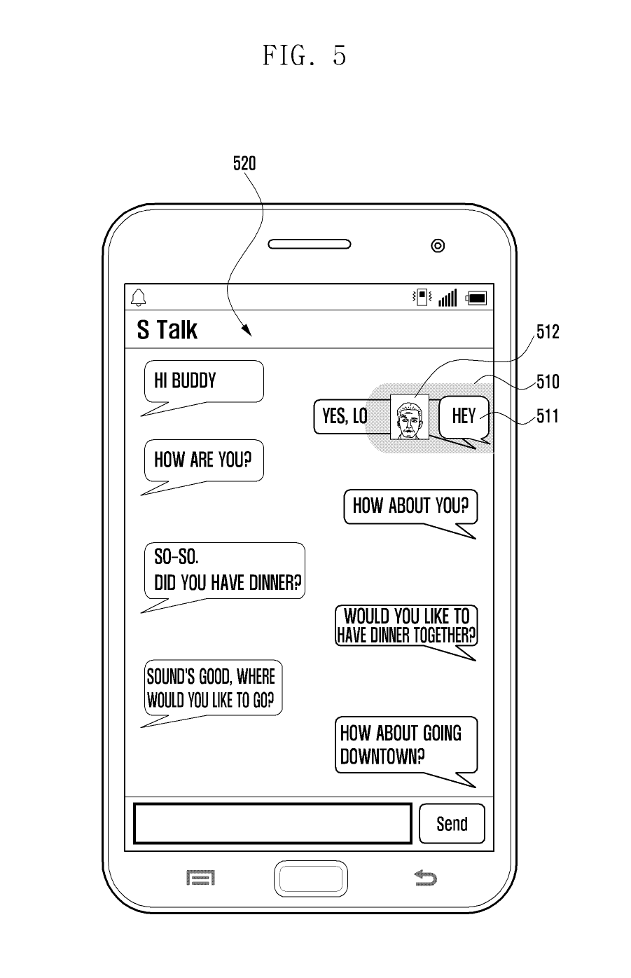

FIG. 5 is a screen for illustrating an example of an operation of displaying a notification bar, such as operation 430 of FIG. 4, according to an embodiment of the present disclosure.

Referring to FIG. 5, the display unit 110 may display a notification bar 510, based on a control of the controller 160. The notification bar 510 may be displayed on the right side of a messenger screen 520 and may include a received message 511. Also, the notification bar 510 may include information that enables a user to identify a sender of the received message 511, for example, a thumbnail 512.

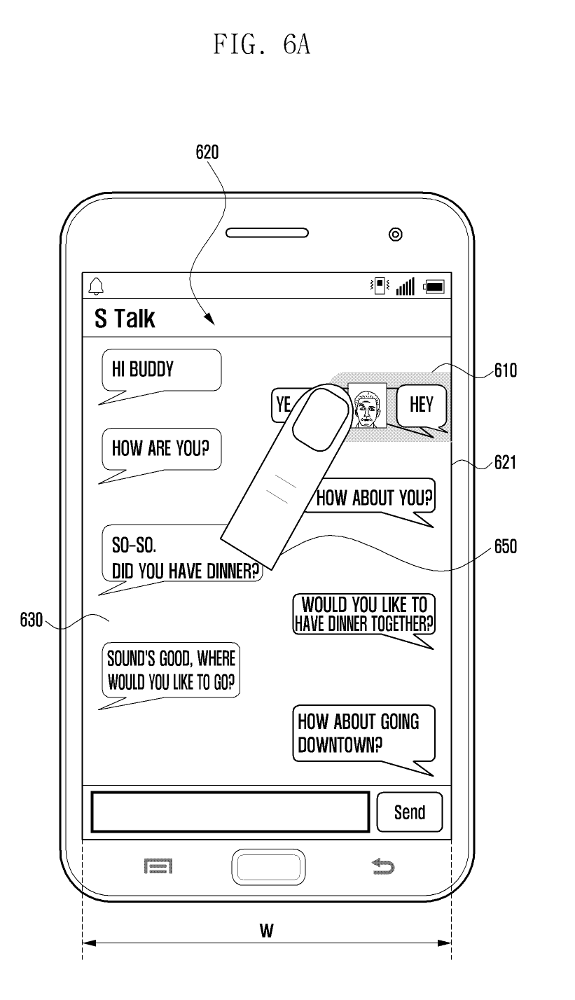

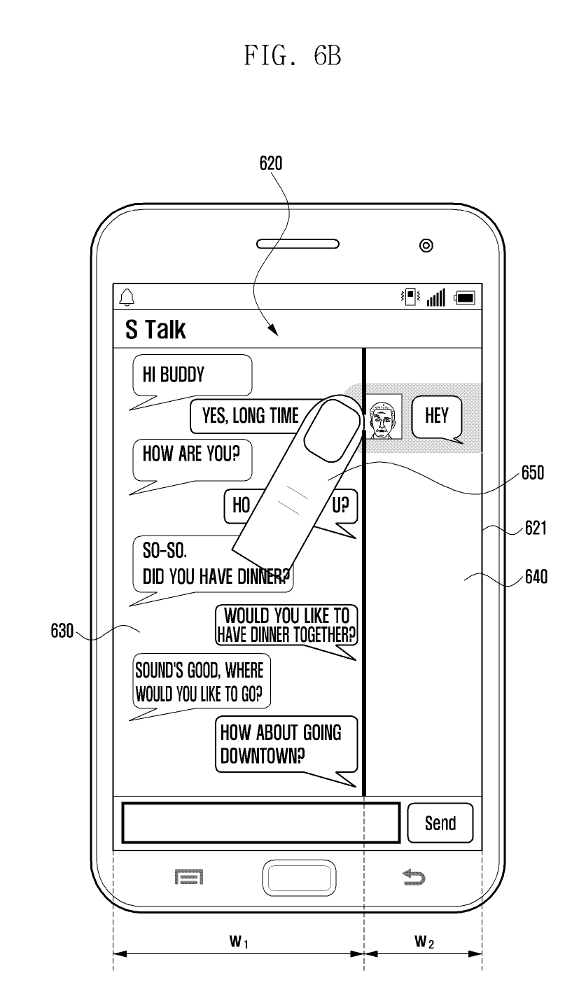

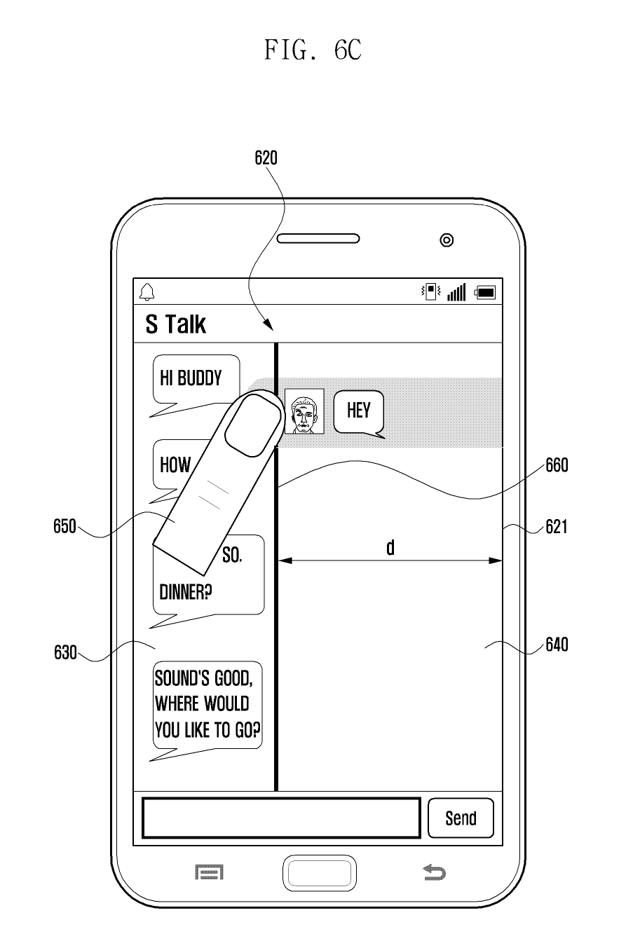

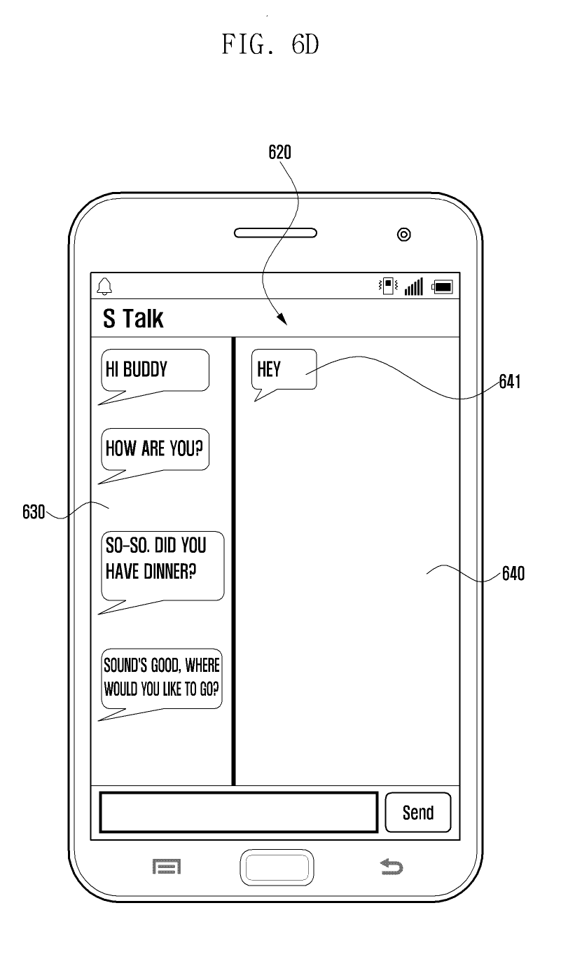

FIGS. 6A, 6B, 6C, and 6D are screens for illustrating an example of a multi-displaying operation, such as operation 450 of FIG. 4, according to an embodiment of the present disclosure.

Referring to FIG. 6A, the controller 160 may control the display unit 110 to display a first chat window 630 on a messenger screen 620. That is, a first chat window 630 may be displayed on an entirety of the messenger screen 620. When a message that is irrelevant to the first chat window 630 is received, the controller 160 may control the display unit 110 to display a notification bar 610 on the right side of the messenger screen 620 so as to notify the user that the message is received.

Referring to FIG. 6B, a user may move a touch input device, for example, a finger 650, to the left side (that is, the inside of the screen), while the touch input device touches the notification bar 610. In response to the movement, the controller 160 may control the display unit 110 to display the notification bar that is moved to the left side. Also, the controller 160 may control the display unit 110 to display a first chat window 630, which is an existing chat window, on the left side of the messenger screen 620, and to display a second chat window 640, which is a new chat window, on the right side of the messenger screen 620.

Referring to FIGS. 6A, 6B, and 6C, the controller 160 may change properties of a chat window based on a distance of a movement of the touch input device, for example, the finger 650. For example, when the finger 650 moves to the left side, the controller 160 may control the display unit 110 to display a width (w1(W−w2)) of the first chat window 630 to be relatively narrower, and to display a width (w2(W−w1)) of the second chat window 640 to be relatively wider. As the finger 650 moves to the left side, the width w1 becomes narrower and the width w2 becomes wider. Also, when the finger 650 moves to the left side, the controller 160 may control the display unit 110 to display a distance between messages from a partner (for example, the messages on the left side of the first chat window 630) and messages from the user (for example, the messages on the right side of the first chat window 630) to be close in the first chat window 630. For example, when a distance (d) between a dividing line 660 and a right outline 621 of the messenger screen 620 exceeds a first threshold, the controller 160 may terminate the display of the messages from the user from the first chat window 630. Also, when the distance (d) exceeds a second threshold (second threshold>first threshold), the controller 160 may terminate the display of the first chat window 630.

Referring to FIG. 6D, when the touch of the finger 650 is released, the controller 160 may control the display unit 110 to display a received message 641 on the second chat window 640.

Unlike FIG. 5 and FIG. 6A, a notification bar may be displayed on the left side of a messenger screen. The user may move the touch input device to the right, while the touch input device touches the notification bar. Then, the controller 160 may control the display unit 110 to display an existing chat window on the right side of the messenger screen, and to display a new chat window on the left side of the messenger screen. In this example, the properties of a chat window may vary based on a distance of a movement of the touch input device, as described above.

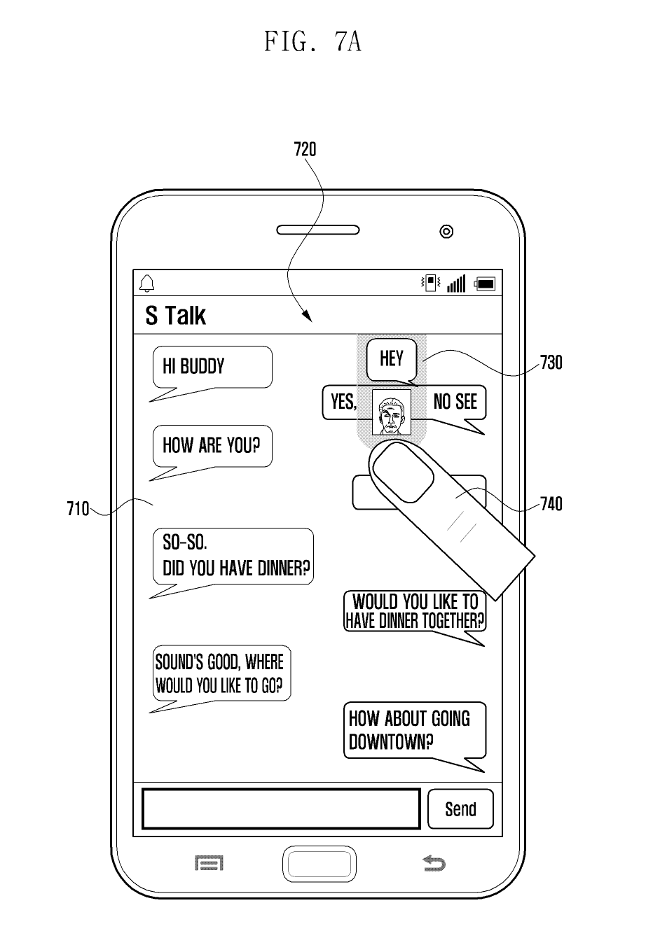

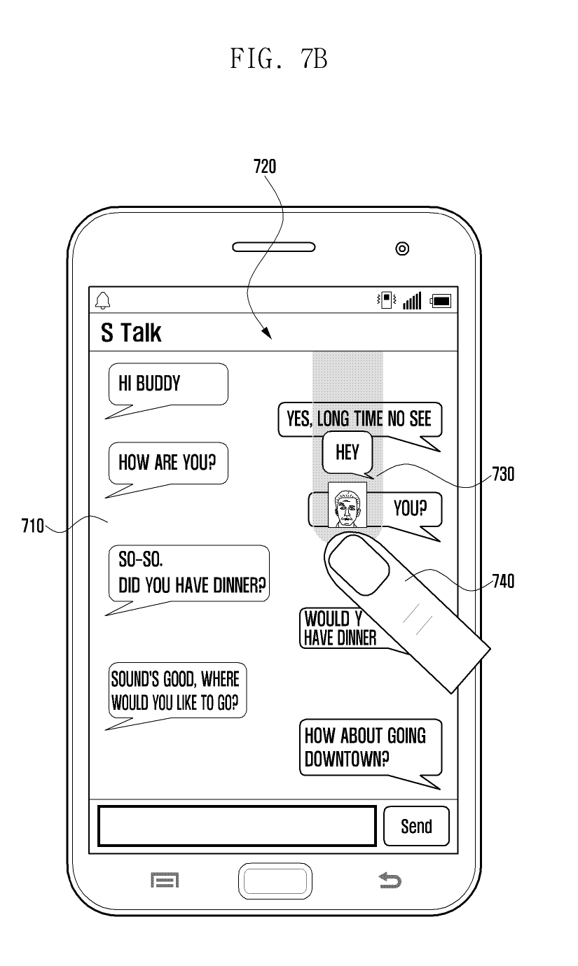

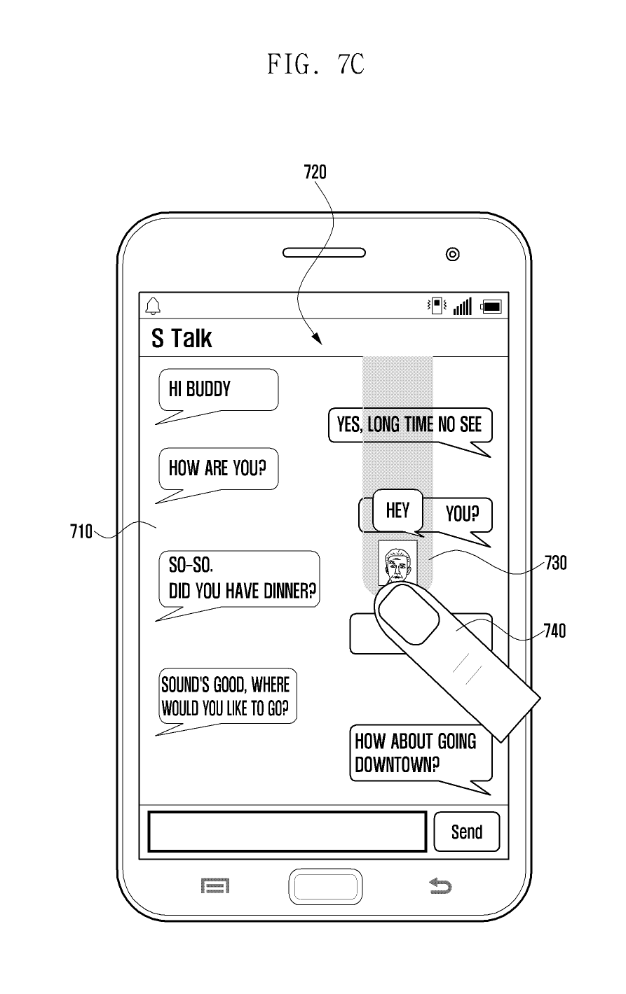

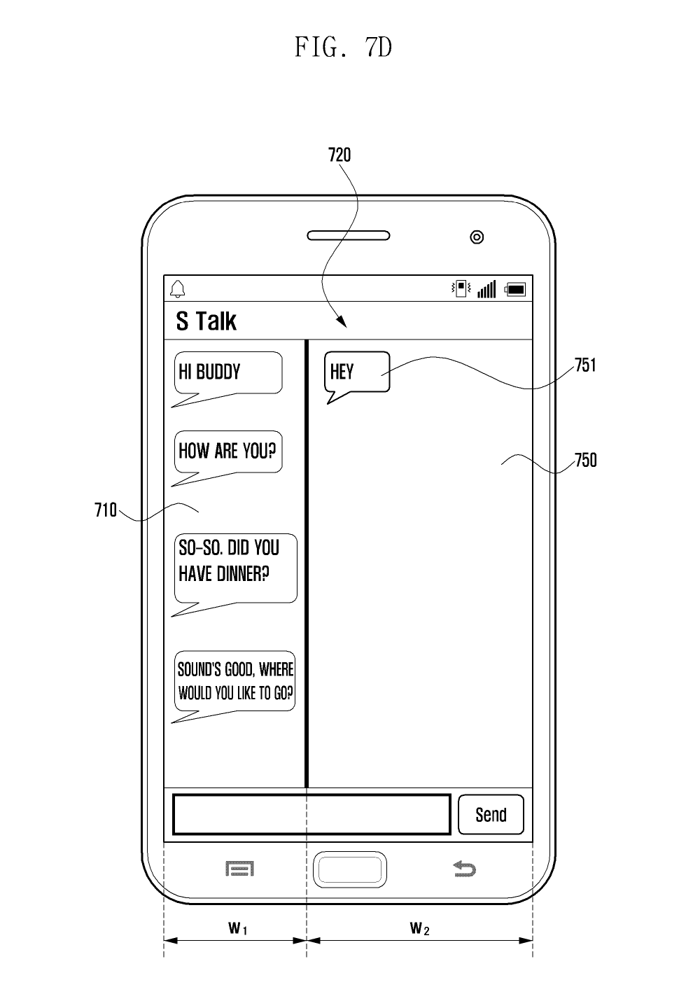

FIGS. 7A, 7B, 7C, and 7D are screens for illustrating an example of a multi-displaying operation, such as operation 450 of FIG. 4, according to an embodiment of the present disclosure.

Referring to FIG. 7A, the controller 160 may control the display unit 110 to display a first chat window 710 on a messenger screen 720. When a message that is irrelevant to the first chat window 710 is received, the controller 160 may control the display unit 110 to display a notification bar 730 on the top end of the messenger screen 720. A user may move a finger 740 down while the finger 740 touches the notification bar 730. In response to the movement, the controller 160 may control the display unit 110 to display the notification bar 730 that is moved down, as illustrated in FIGS. 7B to 7D.

When the touch of the finger 740 is released, the controller 160 may control the display unit 110 to display the first chat window 710, which is an existing chat window, on the left side of the messenger screen 720, and to display a second chat window 750, which is a new chat window, on the right side of the messenger screen 720. Also, the controller 160 may control the display unit 110 to display a received message 751 in the second chat window 750. The properties of a chat window may be changed based on a distance of a movement of the finger 740. For example, a width (w2) of the second chat window 750 may be proportional to a distance of a movement of the finger 740. For example, a width (w2) of the first chat window 710 may be proportional to a distance of a movement of the finger 740. Also, when w1>w2, both messages from the user and messages from a partner are displayed in the first chat window 710, and only messages from a partner may be displayed in the second chat window 750. As the width of w1 is narrower (only when, w1>w2), a distance between the messages from the partner and the messages from the user may become narrower in the first chat window 710. Also, as the width of w1 is narrower (only when, w1>w2), a font size of the messages from the user may become smaller than a font size of the messages from the partner in the first chat window 710. When w2>w1, only the messages from the partner may be displayed in the first chat window 710, as illustrated in FIG. 7D, and both the messages from the partner and the messages from the user may be displayed in the second chat window 750.

Unlike FIG. 7A, a notification bar may be displayed on the lower end of a messenger screen. When the user moves a touch input device up while the touch input device touches the notification bar, and releases the touch, the controller 160 may control the display unit 110 to display an existing chat window on the right side of the messenger screen and to display a new chat window on the left side of the messenger screen. In this example, the properties of a chat window may vary based on a distance of a movement of the touch input device, as described above.

Also, unlike the examples of FIGS. 7A through 7D, a new chat window may be displayed before the touch of the touch input device is released. When the finger 740 moves down, the controller 160 may control the display unit 110, for example, to display the first chat window 710, which is an existing chat window, on the lower end of the messenger screen 720, and to display the second chat window 750, which is a new chat window, on the top end of the messenger screen 720.

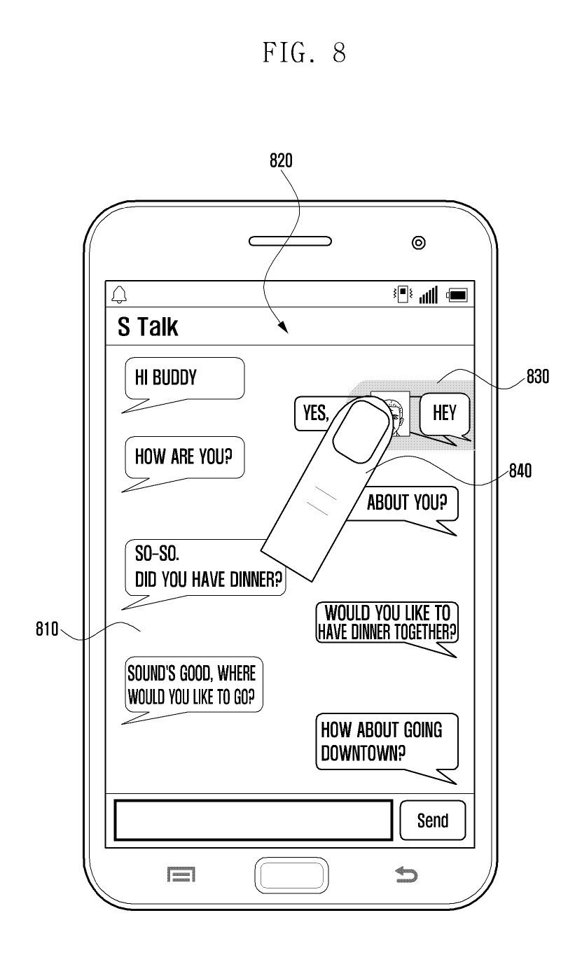

FIG. 8 is a screen for illustrating an example of a multi-displaying operation, such as operation 450 of FIG. 4, according to an embodiment of the present disclosure.

Referring to FIG. 8, the controller 160 may control the display unit 110 to display a first chat window 810 on a messenger screen 820. When a message that is irrelevant to the first chat window 810 is received, the controller 160 may control the display unit 110 to display a notification bar 830 on the right side of the messenger screen 820. The user may tap on the notification bar 830 with a finger 840. Then, the controller 160 may control the display unit 110 to display the first chat window 810, which is an existing chat window, and a new chat window on the messenger screen 820. In this example, the controller 160 may control the display unit 110 to display chat windows based on property information stored in the memory 150. For example, the first chat window 810 and a second chat window may be displayed as illustrated in one of FIGS. 3A, 3B, 3C, and 3D.

As described above, two chat windows may be displayed on a messenger screen. As matter of course, three or more chat windows may be displayed on a messenger screen.

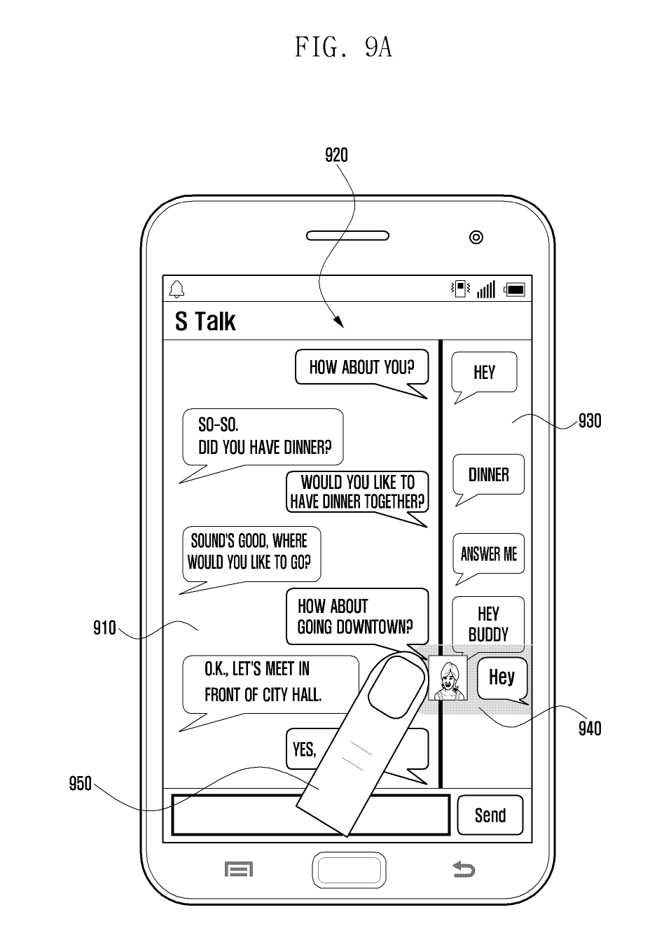

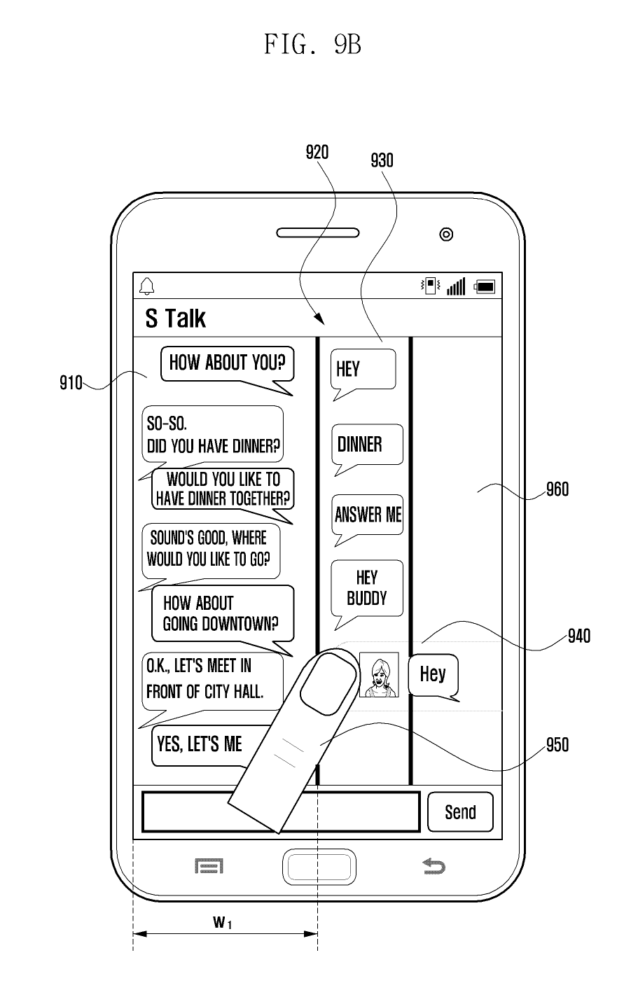

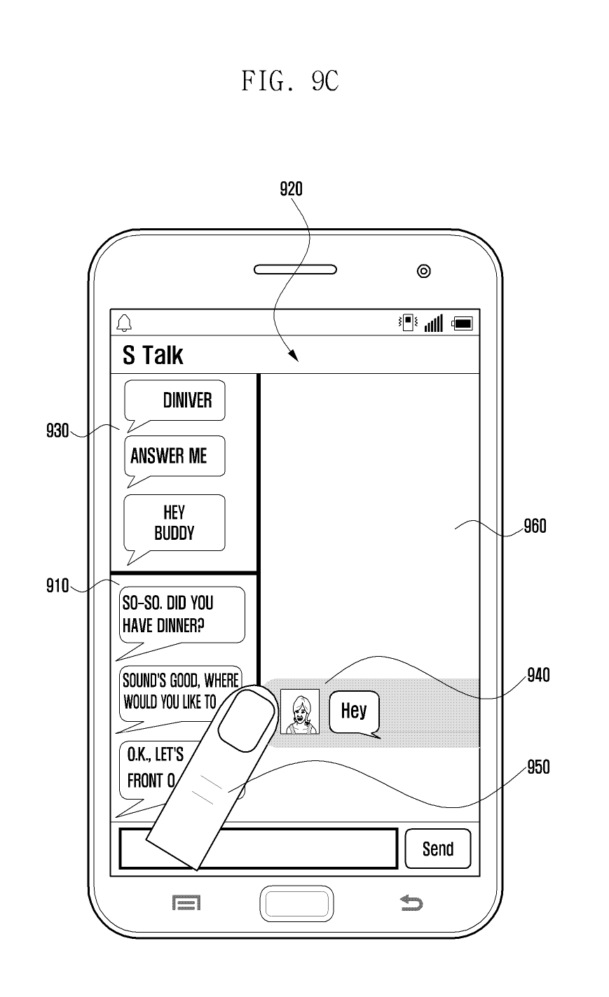

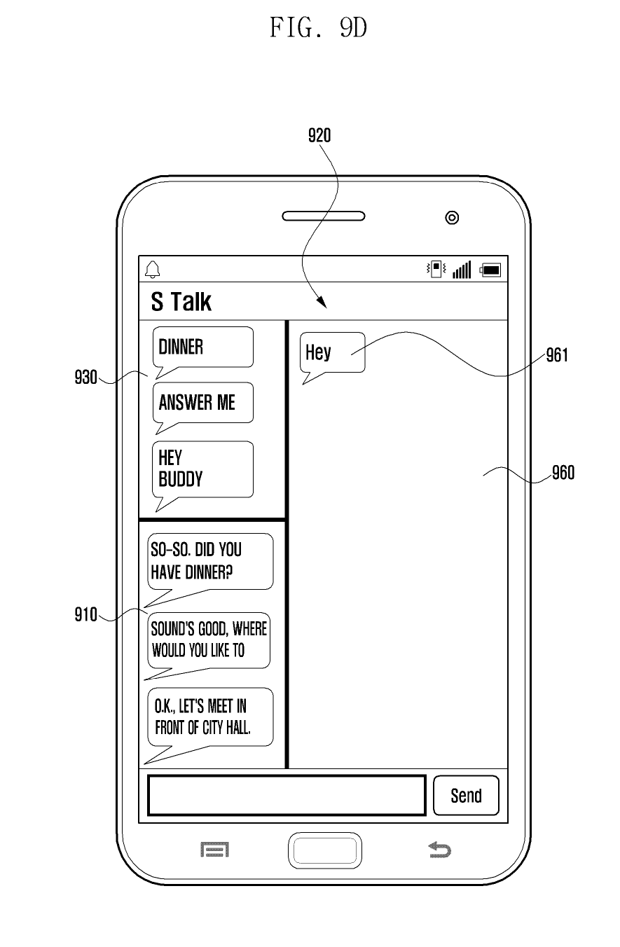

FIGS. 9A, 9B, 9C, and 9D are screens for illustrating an example of an operation of displaying three or more chat windows on a messenger screen according to an embodiment of the present disclosure.

Referring to FIG. 9A, the controller 160 may control the display unit 110 to display a first chat window 910 on the left side of the messenger screen 920, and to display a second chat window 930 on the right side of the messenger screen 920. When a message that is irrelevant to the chat windows 910 and 930 is received, the controller 160 may control the display unit 110 to display a notification bar 940 on the right side of the messenger screen 920.

Referring to FIG. 9B, a user may move a touch input device, for example, a finger 950, to the left side, while the user touch input touches the notification bar 940. In response to the movement, the controller 160 may control the display unit 110 to display the notification bar 940 that is moved to the left side. Also, in response to the movement, the controller 160 may control the display unit 110 to display a third chat window 960 on the right side of the messenger screen 920. Also, in response to the movement, the controller 160 may reduce a width (w1) of the first chat window 910. Accordingly, a distance between messages from a partner and messages from the user may narrow in the first chat window 910.

Referring to FIG. 9C, when the finger 950 moves to the left side a little more than shown in FIG. 9B, the controller 160, in response to this, may control the display unit 110 to display the first chat window 910 on the lower end of the messenger screen 920 and to display the second chat window 930 on the displayed first chat window 910. As described above, a condition for displaying the two chat windows 910 and 930 to be layered may be, for example, a case in which w1 is less than a threshold value. That is, when w1<threshold value, the controller 160 may control the display unit 110 to display the two chat windows 910 and 930 to be layered and to display the third chat window 960 on the side of the two chat windows 910 and 930. Also, when the two chat windows 910 and 930 are layered in contact with each other, the controller 160 may control the display unit 110 to display only messages from a partner in the first chat window 910 and the second chat window 930.

Referring to FIG. 9D, when the touch of the finger 950 is released, the controller 160 may control the display unit 110 to display a received message 961 in the third chat window 960.

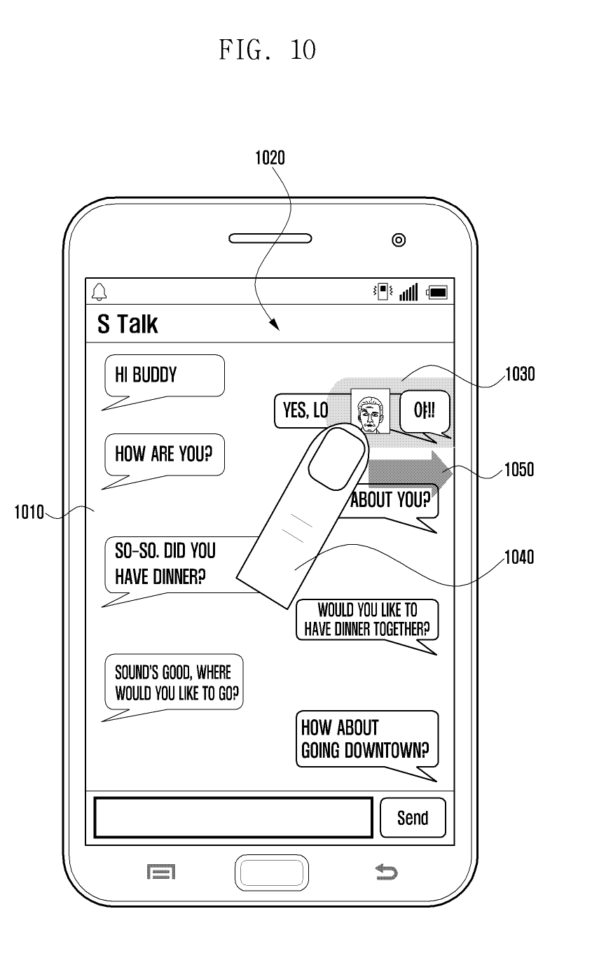

FIG. 10 is a screen for illustrating an operation of terminating a display of a notification bar, such as operation 480 of FIG. 4, according to an embodiment of the present disclosure.

Referring to FIG. 10, the controller 160 may control the display unit 110 to display a chat window 1010 on a messenger screen 1020. When a message that is irrelevant to the chat window 1010 is received, the controller 160 may control the display unit 110 to display a notification bar 1030 on the right side of the messenger screen 1020. A user may move 1050 a touch input device, for example, a finger 1040, to the right side (that is, the outside of the screen) while the touch input device touches the notification bar 1030. In response to the movement 1050, the controller 160 may terminate the display of the notification bar 1030.

As described above, a plurality of chat windows may be displayed on a messenger screen. However, the number of chat windows to be displayed on the messenger screen may be limited.

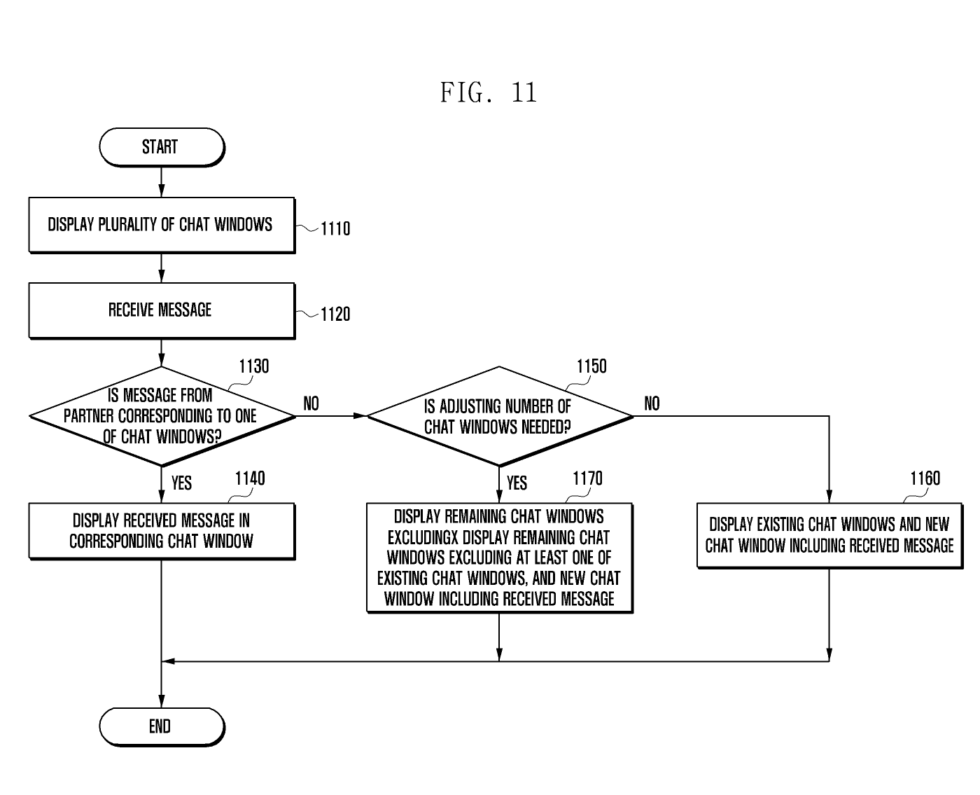

FIG. 11 is a flowchart illustrating a method of displaying a plurality of chat windows according to an embodiment of the present disclosure.

Referring to FIG. 11, the controller 160 may control the display unit 110 to display a plurality of chat windows in operation 1110. In operation 1120, the controller 160 receives a message through the wireless communication unit 130 from the outside. When the message is received in operation 1120, the controller 160 may determine whether the received message corresponds to any one of the displayed chat windows in operation 1130.

When it is determined that the received message corresponds to any one of the plurality of chat windows in operation 1130, the controller 160 may control the display unit 110 to display the received message in the corresponding chat window in operation 1140.

When it is determined that the received message is irrelevant to the chat windows in operation 1130, the controller 160 may determine whether the number of chat windows needs to be adjusted in operation 1150. For example, the number of chat windows to be displayed may be set in advance to, for example, 2. Then, when the number of currently displayed chat windows is 2, the controller 160 may determine that the number of chat windows needs to be adjusted. Also, the controller 160 may determine whether the number of displayed chat windows needs to be adjusted based on history information for each displayed chat window. For example, a chat window in which messages are not made during a period of time (for example, 1 minute) (that is, a chat window in which a message is not transmitted or received over 1 minute) exists among the displayed chat windows, the controller 160 may determine that adjusting the number of chat windows is required.

When it is determined that adjusting the number of chat windows is not required in operation 1150, the controller 160 may control the display unit 110 to display existing chat windows and a new chat window including the received message in operation 1160.

When it is determined that adjusting the number of chat windows is required in operation 1150, the controller 160 may control the display unit 110 to display the remaining chat windows excluding at least one of the existing chat windows, and a new chat window including the received message in operation 1170. Here, the chat window that is excluded from the display may be a chat window that is displayed earliest in time. Also, the chat window that is excluded from the display may be a chat window in which messages are not made during a period of time. The chat window excluded from the display may be replaced with an indicator. That is, the controller 160 may control the display unit 110 to display an indicator indicating the corresponding chat window on the messenger screen in return for terminating the display of the chat window.

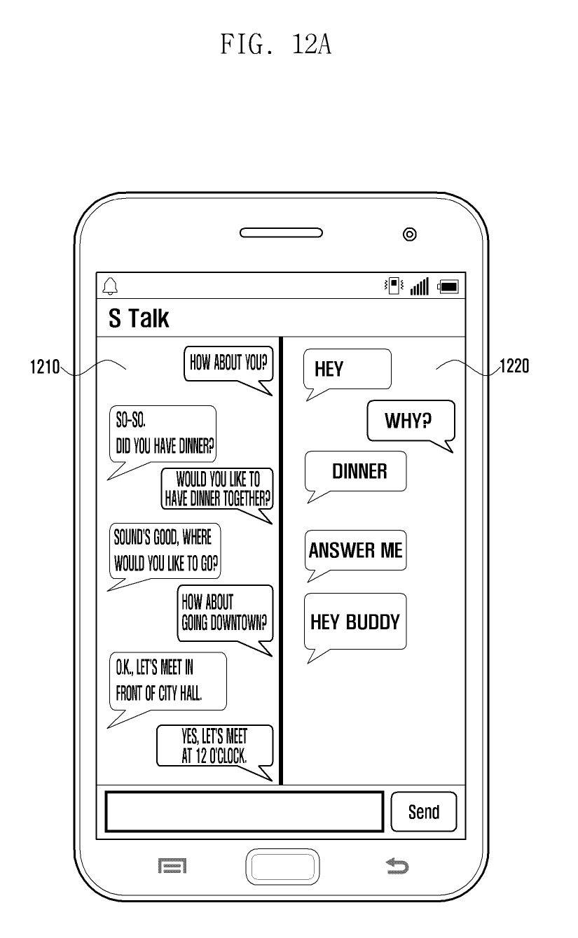

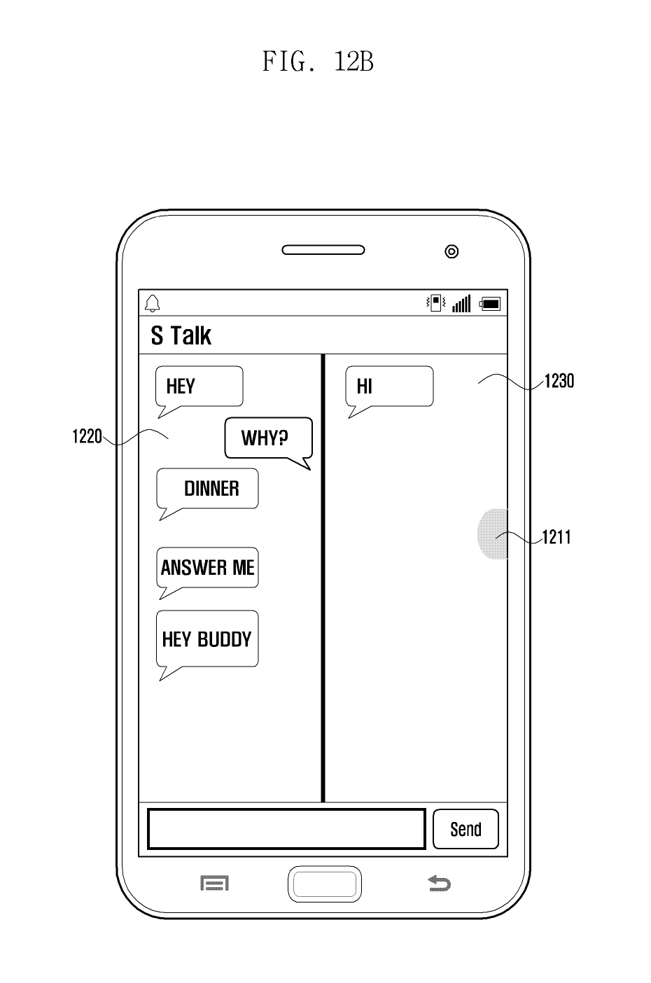

FIGS. 12A and 12B are screens for illustrating an example of displaying remaining chat windows excluding at least one existing chat window and a new chat window including a received message, such as operation 1170 of FIG. 11, according to an embodiment of the present disclosure.

Referring to FIGS. 12A and 12B, a first chat window 1210 and a second chat window 1220 are displayed. In this example, when a message that is irrelevant to the chat windows 1210 and 1220 is received, the controller 160 may determine whether the number of chat windows needs to be adjusted. For example, when a message is not transmitted or received for over one minute in the first chat window 1210, the controller 160 may terminate the display of the first chat window 1210. The controller 160 may control the display unit 110 to display the second chat window 1220 and a third chat window 1230 including the received message. In this example, the controller 160 may control the display unit 110 to terminate the display of the first chat window 1210 and to display an indicator 1211 indicating the first chat window 1210 on the right side of a screen. When a user selects the indicator 1211 (for example, by tapping on the indicator 1211), the first chat window 1210 may be displayed again on the screen, together with at least one of the other chat windows 1220 and 1230.

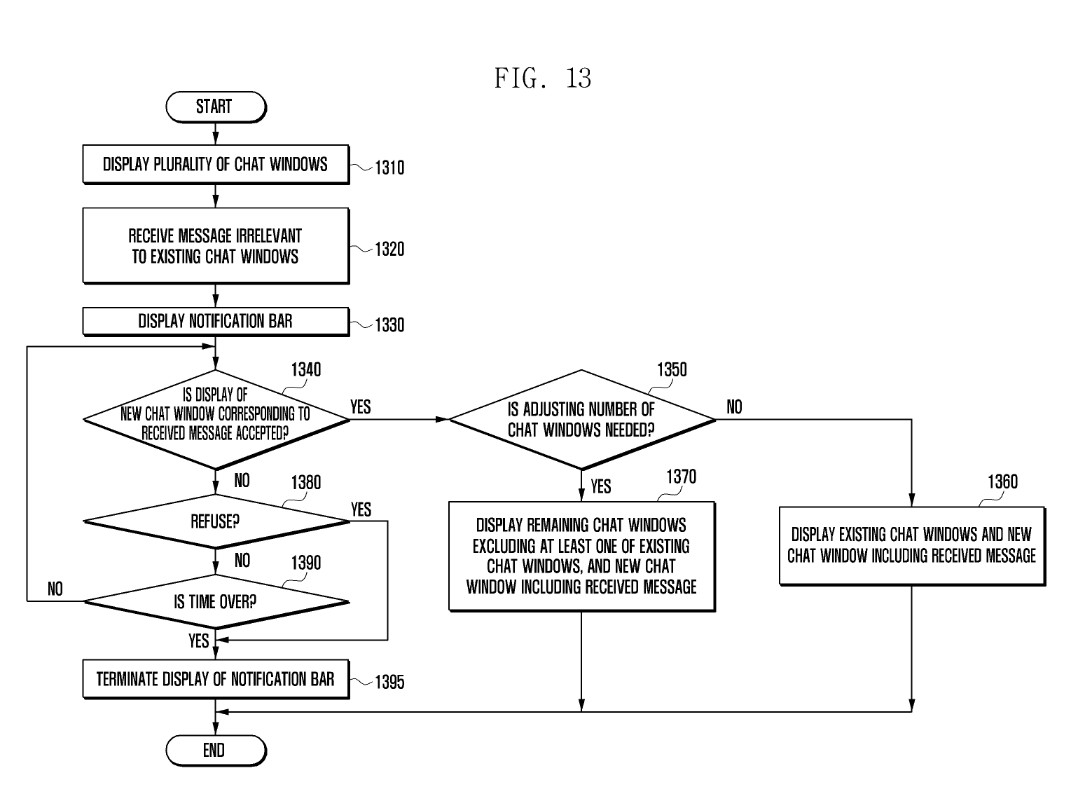

FIG. 13 is a flowchart illustrating a method of displaying a plurality of chat windows according to an embodiment of the present disclosure.

Referring to FIG. 13, the controller 160 may control the display unit 110 to display a plurality of chat windows in operation 1310. In operation 1320, the controller 160 receives a message that is irrelevant to currently displayed chat windows, through the wireless communication unit 130. Accordingly, in operation 1330, the controller 160 may control the display unit 110 to display a notification bar on a messenger screen. In operation 1340, the controller 160 may determine whether a user input (hereinafter, an accept input) that allows the display of a new chat window corresponding to the received message is detected. When it is determined that the accept input is detected in operation 1340, the controller 160 may determine whether the number of chat windows needs to be adjusted in operation 1350. When it is determined that adjusting the number of chat windows is not required in operation 1350, the controller 160 may control the display unit 110 to display the existing chat windows and a new chat window including the received message in operation 1360. When it is determined that adjusting the number of chat windows is required in operation 1350, the controller 160 may control the display unit 110 to display the remaining chat windows excluding at least one of the existing chat windows, and the new chat window including the received message in operation 1370.

When the accept input is not detected in operation 1340, the controller 160 may determine whether a user input that refuses the display of the new chat window (hereinafter, a refusal input) is detected in operation 1380. When the refusal input is detected in operation 1380, the process may proceed with operation 1395.

When the refusal input is not detected in operation 1380, the controller 160 may determine whether an amount of critical time passes in operation 1390. For example, the controller 160 may count the time from when the message is received (or displaying a notification bar). When the counted time does not exceed the critical time, the process may return to operation 1340.

When the counted time exceeds the critical time, the process may proceed with operation 1395. Alternatively, when the counted time exceeds the critical time, the process may be set to proceed with operation 1350.

In operation 1395, the controller 160 may terminate the display of the notification bar.

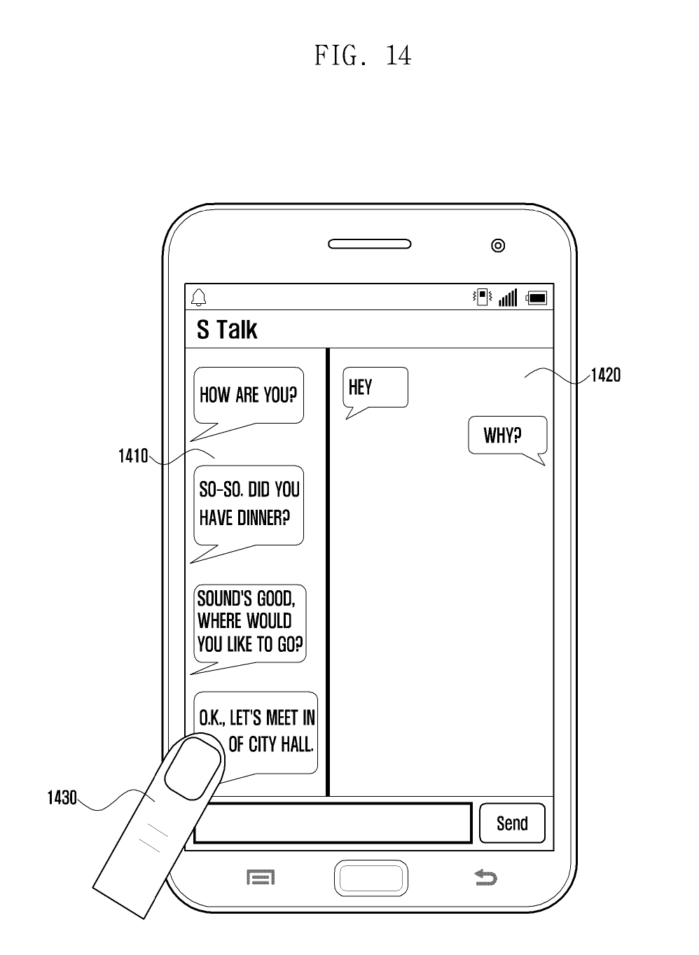

FIG. 14 is a screen for illustrating an example of an operation of setting a displayed chat window to be an active window according to an embodiment of the present disclosure.

Referring to FIG. 14, a first chat window 1410 may be displayed on the left side of a messenger screen, and a second chat window 1420 may be displayed on the right side of the messenger screen. In this example, when a user taps a touch input device, for example, a finger 1430, on the first chat window 1410. In response to the user input, the controller 160 may set the first chat window 1410 to an active window, and may set the second chat window 1420 to an inactive window. Here, the user input may be an input through the touch panel 111. Also, the user input may be an input through the key input unit 120, a MIC, an acceleration sensor, or the like.

The controller 160 may change the properties of the active first chat window 1410. Also, the controller 160 may change the properties of the inactive second chat window 1420. For example, the controller 160 may control the display unit 110 to display a width of the first chat window 1410 to be wider than the second chat window 1420. Also, the controller 160 may control the display unit 110 to display both messages from a partner and messages from the user on the active first chat window 1410. Also, the controller 160 may control the display unit 110 to display only messages from a partner on the inactive second chat window 1420. In addition, information associated with the properties may include a font color, a font, a font size, a size of a chat window, a size of a word box, a shape of a word box, a color of a word box, an amount of message (that is, the number of word boxes), a type of message, and the like.

The positions of an active window and an inactive window may be changed. For example, as the first chat window 1410 is active, the controller 160 may control the display unit 110 to change the position of the first chat window 1410 and the position of the second chat window 1420, for the display. The position of an active window may be set by the user. That is, “active window position information” set by the user may be stored in the memory 150, and the controller 160 may change the positions of an active window and an inactive window based on the position information.

In a state in which the first chat window 1410 and the second chat window 1420 are displayed, when a message associated with one of the two chat windows is received, a corresponding chat window may be changed to be in an active state.

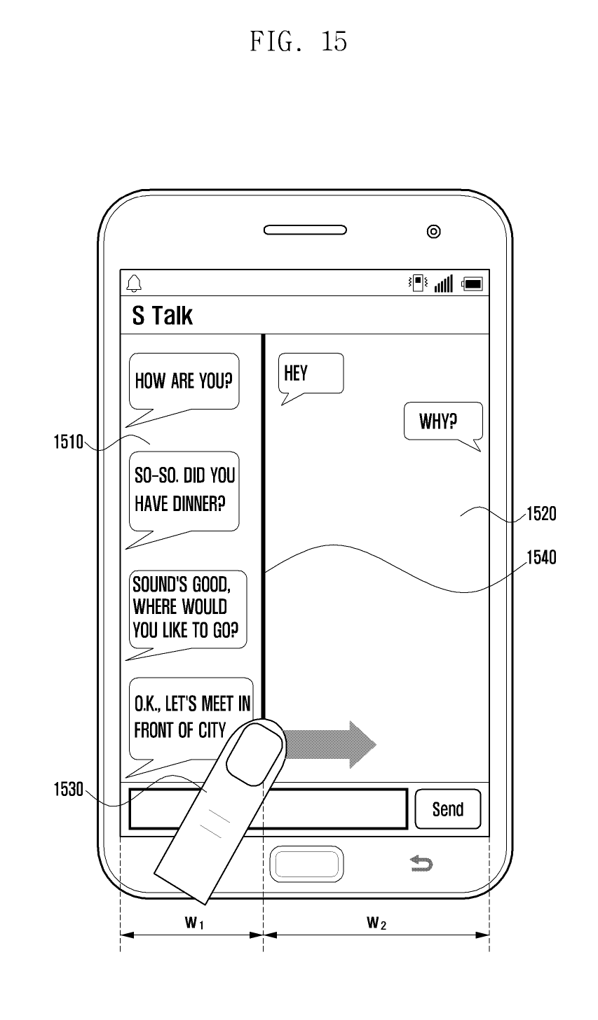

FIG. 15 is a screen for illustrating an example of an operation of setting a displayed chat window to an active window according to an embodiment of the present disclosure.

Referring to FIG. 15, a first chat window 1510 may be displayed on the left side of a messenger screen, and a second chat window 1520 may be displayed on the right side of the messenger screen. Here, a width of the first chat window 1510 may be displayed to be narrower than the second chat window 1520, as illustrated in the drawing. Then, the controller 160 may set the first chat window 1510 to an inactive window, and may set the second chat window 1520 to an active window. In this example, a user may move a touch input device, for example, a finger 1530, to the right side, while the touch input device touches a dividing line 1540 that distinguishes the two chat windows 1510 and 1520. In response to the movement, the controller 160 may control the display unit 110 to display the dividing line 1540 that is moved to the right side. Accordingly, the width (w1) of the first chat window 1510 becomes wider and a width (w2) of the second chat window 1520 becomes narrower. When w1>w2, the controller 160 may set the first chat window 1510 to an active window, and may set the second chat window 1520 to an inactive window.

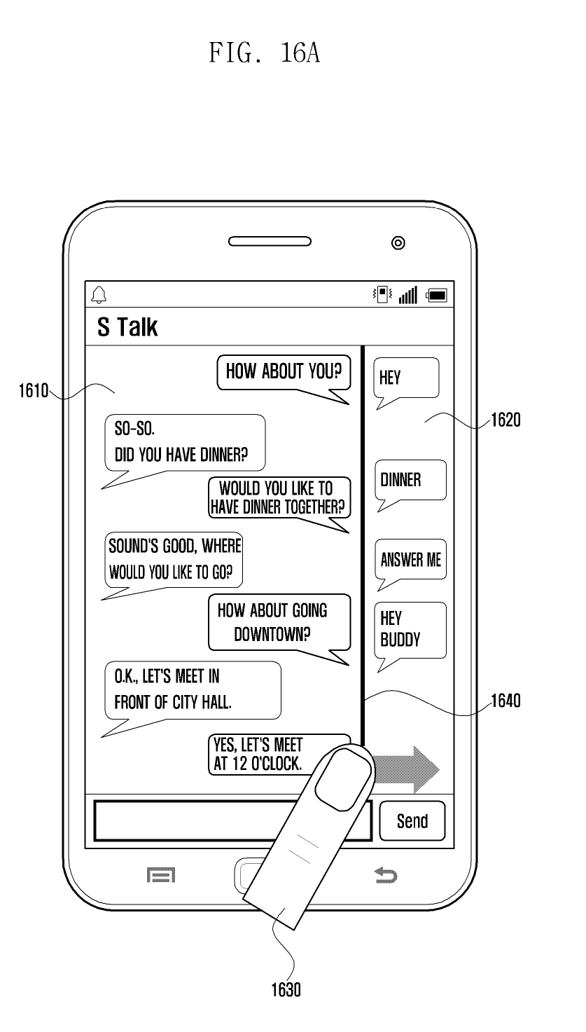

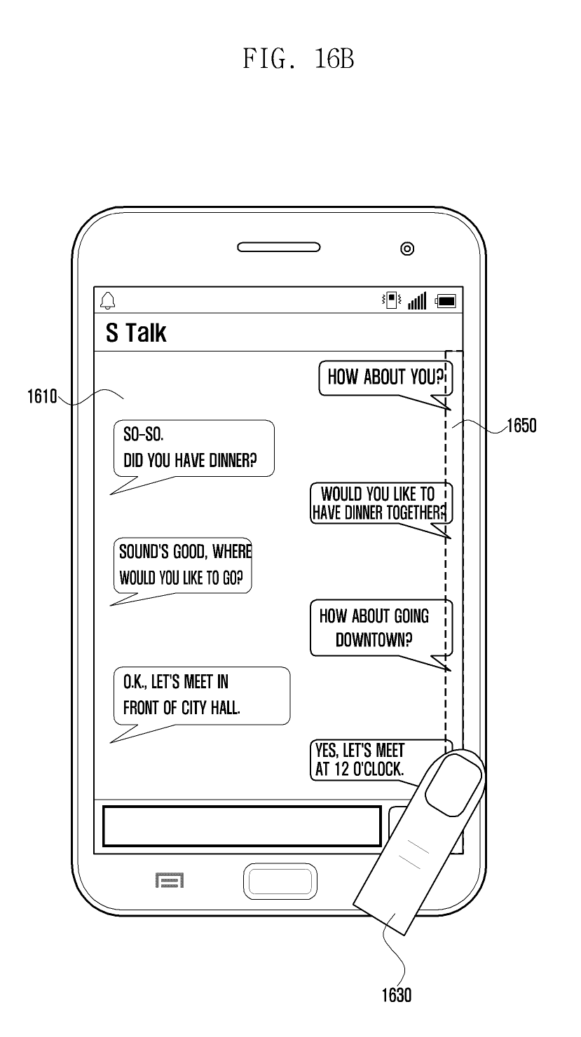

FIGS. 16A and 16B are screens for illustrating an example of an operation of terminating a multi-displaying mode according to an embodiment of the present disclosure.

Referring to FIG. 16A, a first chat window 1610 may be displayed on the left side of a messenger screen, and a second chat window 1620 may be displayed on the right side of the messenger screen. In this example, a user may move a touch input device, for example, a finger 1630, to the right side, while the touch input device touches a dividing line 1640 that distinguishes the two chat windows 1610 and 1620. In response to the movement, the controller 160 may control the display unit 110 to display the dividing line 1640 that is moved to the right side.

Referring to FIG. 16B, when the finger 1630 arrives at a right side area 1650 of the messenger screen, the controller 160 may terminate the display of the second chat window 1620. That is, the controller 160 may control the display unit 110 to display only the first chat window 1610 on the entire screen.

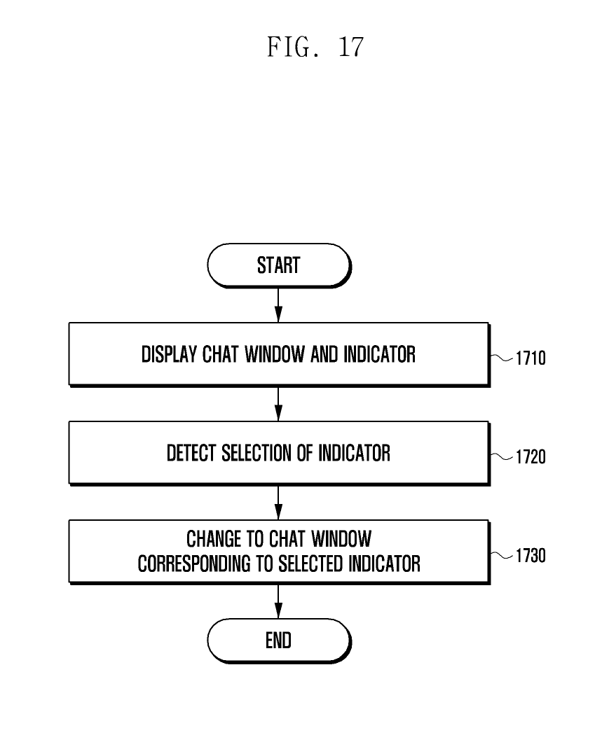

FIG. 17 is a flowchart illustrating a method of selectively displaying one of a plurality of chat windows according to an embodiment of the present disclosure.

Referring to FIG. 17, the controller 160 may control the display unit 110 to display a chat window and at least one indicator on a messenger screen in operation 1710. Here, the indicator indicates another chat window. In operation 1720, the controller 160 may detect a user input for selecting an indicator (for example, a user taps on a displayed indicator). When the user input for selecting the indicator is detected in operation 1720, the controller 160 may control the display unit 110 to display a chat window corresponding to the selected indicator on the messenger screen in operation 1730.

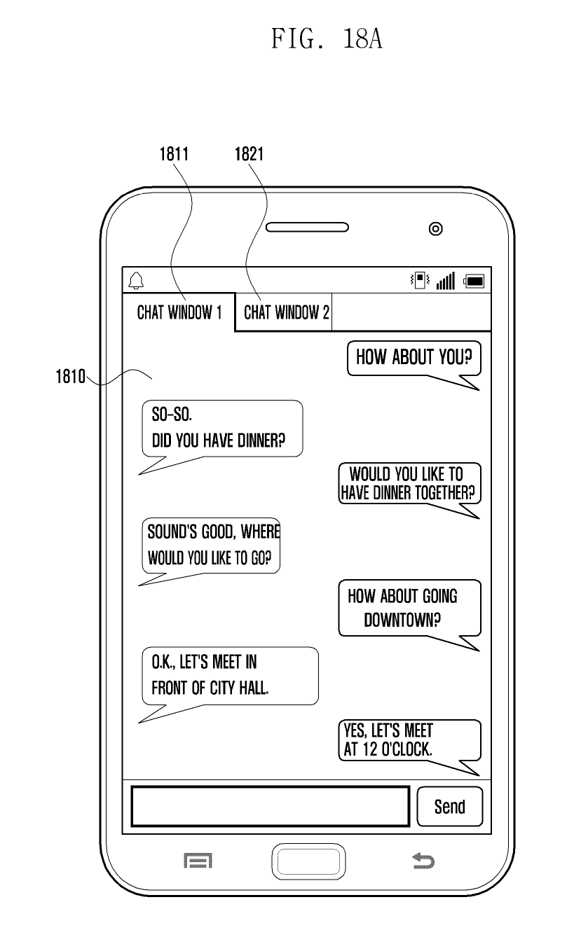

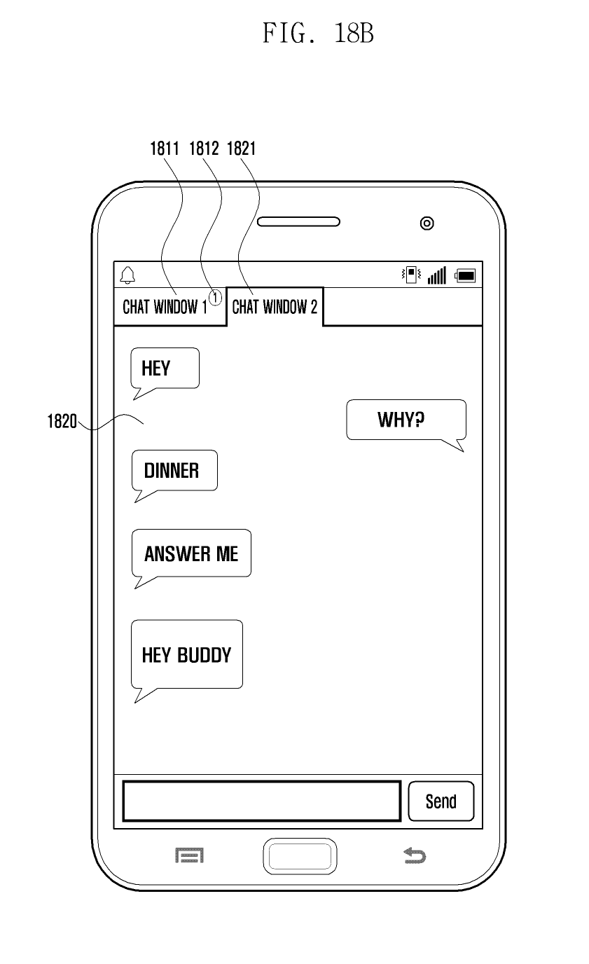

FIG. 18A and FIG. 18B are screens for illustrating an example of displaying a chat window corresponding to a selected indicator on a messenger screen, such as operation 1730 of FIG. 17, according to an embodiment of the present disclosure.

Referring to FIG. 18A, the controller 160 may control the display unit 110 to display a first chat window 1810 on a messenger screen. Also, the controller 160 may control the display unit 110 to display a first indicator 1811 indicating the first chat window 1810 and a second indicator 1821 indicating a second chat window 1820 on the messenger screen. Here, the display of the first indicator 1811 may be omitted. That is, an indicator for a currently displayed chat window may not be displayed.

Referring to FIG. 18B, a user may tap a touch input device on the second indicator 1821. Also, the user may move the touch input device down (to the inside of the screen) while the touch input device touches the second indicator 1821. In response to the tap, that is, a touch gesture such as dragging to the inside of the screen, flicking to the inside of the screen, or the like, the controller 160 may control the display unit 110 to terminate the display of the first chat window 1810 and to display the second chat window 1820 on the messenger screen. Also, in a state in which the first chat window 1810 is displayed, when a message associated with the second chat window 1820 is received, the controller 160 may control the display unit 110 to terminate the display of the first chat window 1810 from the messenger screen, and to display the second chat window 1820 on the messenger screen.

In a state in which the second chat window 1820 is displayed, when a message associated with the first chat window 1810 is received, the controller 160 may notify the user that the message associated with the first chat window 1810 is received. For example, referring to FIG. 18B, a notification 1812 indicating the number of received messages, for example, “1” may be displayed. When the user selects the notification 1812 (for example, a tap on the notification 1812), the controller 160 may control the display unit 110 to terminate the display of the second chat window 1820 from the messenger screen, and to display the first chat window 1810 on the messenger screen. Also, when the first chat window 1810 is displayed, the display of the notification 1812 may be terminated.

A method according to the present disclosure as described above may be implemented as a program command which can be executed through various computers and recorded in a computer-readable recording medium. The recording medium may include a program command, a data file, and a data structure. The program command may be specially designed and configured for the present disclosure or may be used after being known to those skilled in computer software fields. The recording medium may include magnetic media such as a hard disk, a floppy disk and a magnetic tape, optical media such as a Compact Disc Read-Only Memory (CD-ROM) and a Digital Versatile Disc (DVD), magneto-optical media such as a floptical disk, and hardware devices such as a ROM, a RAM and a flash memory. Further, the program command may include a machine language code generated by a compiler and a high-level language code executable by a computer through an interpreter and the like. The hardware devices may be configured to operate as one or more software modules to realize the present disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of operating an electronic device, the method comprising:
displaying a first chat window on a messenger screen;
determining whether to display a second chat window; and
displaying the first chat window and the second chat window on the messenger screen when it is determined that the second chat window is to be displayed.

2. The method of claim 1, wherein the determining of whether to display the second chat window comprises receiving a message from the outside and determining to display the second chat window when the received message is irrelevant to the first chat window, and wherein the displaying of the first chat window and the second chat window on the messenger screen comprises displaying, on the messenger screen, the first chat window and the second chat window including the received message.

3. The method of claim 2, wherein the displaying of the first chat window and the second chat window on the messenger screen comprises:
displaying, on the messenger screen, a notification bar associated with the received message when the received message is irrelevant to the first chat window; and
displaying, on the messenger screen, the first chat window and the second chat window, in response to a user input that selects the notification bar.

4. The method of claim 3, wherein the displaying of the notification bar on the messenger screen comprises:
including at least one of the received message and identification information for identifying the received message in the notification bar; and
displaying the notification bar on the messenger screen.

5. The method of claim 1, further comprising:
generating a third chat window; and
displaying, on the messenger screen, the generated third chat window together with the first chat window.

6. The method of claim 1, wherein the displaying of the first chat window and the second chat window on the messenger screen comprises:
displaying the first chat window and the second chat window to have different properties from each other.

7. The method of claim 6, wherein the displaying of the first chat window and the second chat window to have different properties from each other comprises:
displaying only one of a transmitted message and a received message which are related to one of the first chat window and the second chat window.

8. The method of claim 6, wherein the displaying of the first chat window and the second chat window to have different properties from each other comprises:
displaying one of the first chat window and the second chat window to be smaller than the other chat window.

9. The method of claim 6, wherein the properties include at least one of a font color, a font, a font size, a size of a chat window, a size of a word box, a shape of a word box, a color of a word box, a number of word boxes, and a type of a message.

10. The method of claim 1, wherein the displaying of the first chat window and the second chat window on the messenger screen comprises:
displaying the first chat window and the second chat window to have different properties from each other, in response to a movement of a touch input device made on the messenger screen.

11. The method of claim 10, wherein the displaying of the first chat window and the second chat window to have different properties from each other comprises:
changing a property of at least one of the first chat window and the second chat window, based on a distance of the movement of the touch input device.

12. The method of claim 1, wherein, when at least one chat window is separately displayed on the messenger screen together with the first chat window, the method further comprises displaying the second chat window on the messenger screen together with the remaining chat window after excluding at least one of the first chat window and the at least one chat window.

13. The method of claim 1, further comprising:
setting one of the first chat window and the second chat window to an active window.

14. The method of claim 13, wherein the active window is a chat window that is capable of transmitting a message.

15. The method of claim 13, wherein the setting of one of the first chat window and the second chat window to an active window comprises:
setting a chat window associated with a received message or a chat window corresponding to a user input to an active window.

16. The method of claim 1, wherein the displaying of the first chat window on the messenger screen comprises displaying the first chat window and at least one indicator on the messenger screen;
the method further comprising:
detecting a user input that selects one of the at least one indicator; and
terminating the display of the first chat window and displaying a second chat window associated with the selected indicator on the messenger screen, in response to the user input.

17. The method of claim 16, wherein, when a message associated with a chat window that is not displayed on the messenger screen is received, the method further comprises displaying, on the messenger screen, a notification indicating that the message is received.

18. An electronic device, comprising:
a display unit configured to display a messenger screen;
a wireless communication unit configured to transmit and receive a message;
a memory configured to store a chatting control module that is set to display a first chat window on the messenger screen, to determine whether to display a second chat window, and to display the first chat window and the second chat window on the messenger screen when it is determined that the second chat window is to be displayed; and
at least one processor configured to execute the chatting control module.

19. The electronic device of claim 18, wherein the chatting control module is set to display the first chat window and at least one indicator on the messenger screen, to detect a user input that selects one of the at least one indicator, to terminate the display of the first chat window and to display a second chat window associated with the selected indicator on the messenger screen in response to the user input.

20. The electronic device of claim 19, wherein, when a message associated with a chat window that is not displayed on the messenger screen is received, the chatting control module is set to display, on the messenger screen, a notification indicating that the message is received.
